(19) United States
(12) Patent Application Publication
(10) Pub. No.: US 2020/0119423 A1
(43) Pub. Date: Apr. 16, 2020

(54) CONNECTION STRUCTURE BETWEEN WAVEGUIDE AND COAXIAL CABLE

(71) Applicants: Nidec Corporation, Kyoto (JP); WGR Co., Ltd., Kyoto-city (JP)

(72) Inventors: Hiroyuki KAMO, Kyoto (JP); Yosuke SATO, Kyoto (JP); Hideki KIRINO, Kyoto-city (JP)

(21) Appl. No.: 16/598,154

(22) Filed: Oct. 10, 2019

(30) Foreign Application Priority Data
Oct. 11, 2018 (JP) 2018-192888

(51) Int. Cl. H01P 3/123; H01P 5/103; G01S 7/02; H01Q 13/02; H01Q 13/18; H01Q 21/06; H01Q 5/55; G01S 13/86

(52) U.S. Cl. CPC H01P 3/123; H01P 5/103; G01S 7/02; G01S 13/867; H01Q 13/18; H01Q 21/064; H01Q 5/55; H01Q 13/02

(57) ABSTRACT

A waveguide device includes a first electrical conductor, a second electrical conductor, a waveguide, electrically conductive rods, and a core. The first electrical conductor includes a first electrically conductive surface. The second electrical conductor includes a second electrically conductive surface opposing the first electrically conductive surface and a throughhole. The waveguide includes a ridge-shaped structure protruding from the second electrically conductive surface and extending along a first direction. At the position of the throughhole, the waveguide is split via a gap into a first ridge and a second ridge having a smaller dimension along the first direction than that of the first ridge.

### CROSS REFERENCE TO RELATED APPLICATION

The present invention claims priority under 35 U.S.C. § 119 to Japanese Application No. 2018-192888 filed on Oct. 11, 2018, the entire contents of which are hereby incorporated herein by reference.

### 1. FIELD OF THE INVENTION

The present disclosure relates to a connection structure between a ridge waveguide and a coaxial cable.

### 2. BACKGROUND

Structures for connecting a hollow waveguide and a coaxial cable have long been known. Great Britain Patent No. 821150 discloses an example of such a connection structure, for example.

On the other hand, waveguides called waffle iron ridge waveguides (WRG) have recently been developed. For example, the specification of U.S. Pat. No. 8,779,995, the specification of U.S. Pat. No. 8,803,638 and Mohamed Al Sharkawy and Ahmed A. Kishk, “Wideband Beam-Scanning Circularly Polarized Inclined Slots Using Ridge Gap Waveguide”, IEEE ANTENNAS AND WIRELESS PROPAGATION LETTERS, VOL. 13, 2014, pp. 1187-1190, disclose examples of such waveguide structures. In the present specification, such waveguides are referred to as “ridge waveguides”. As for ridge waveguides, too, connection with coaxial cables has been contemplated. For example, the specification of U.S. Pat. No. 8,803,638 and Mohamed Al Sharkawy and Ahmed A. Kishk, “Wideband Beam-Scanning Circularly Polarized Inclined Slots Using Ridge Gap Waveguide”, IEEE ANTENNAS AND WIRELESS PROPAGATION LETTERS, VOL. 13, 2014, pp. 1187-1190, disclose examples of such connection structures.

Mohamed Al Sharkawy and Ahmed A. Kishk, “Wideband Beam-Scanning Circularly Polarized Inclined Slots Using Ridge Gap Waveguide”, IEEE ANTENNAS AND WIRELESS PROPAGATION LETTERS, VOL. 13, 2014, pp. 1187-1190 discloses a construction in which the core of a coaxial cable and the electrically conductive surface of an electrically conductive plate composing a ridge waveguide are in contact. In this construction, however, minute changes in the state of contact at the contact portion will alter the electrical state of the connection between the coaxial cable and the ridge waveguide. A structure which connects a ridge waveguide and a coaxial cable and which maintains stable electrical characteristics is being desired.

### SUMMARY

A waveguide device according to an example embodiment of the present disclosure includes a first electrical conductor including a first electrically conductive surface including an expanse along a first direction and a second direction which intersects the first direction, a second electrical conductor including a second electrically conductive surface opposing the first electrically conductive surface and including a throughhole, and a ridge-shaped waveguide protruding from the second electrically conductive surface and extending along the first direction. The waveguide includes an electrically-conductive waveguide surface opposing the first electrically conductive surface, and the waveguide is split into a first ridge and a second ridge having a smaller dimension along the first direction than the first ridge via a gap which overlaps the throughhole when viewed from a direction perpendicular or substantially perpendicular to the waveguide surface. The waveguide device further includes a plurality of electrically conductive rods which are located around the waveguide, each of the plurality of electrically conductive rods including a root that is connected to the second electrically conductive surface and a leading end that is opposed to the first electrically conductive surface. The waveguide device also includes a core which is partly accommodated in the throughhole and is connected to an end surface of the first ridge opposing an end surface of the second ridge via the gap or connected to the end surface of the second ridge.

A waveguide device according to another example embodiment of the present disclosure includes a first electrical conductor including a first electrically conductive surface including an expanse along a first direction and a second direction which intersects the first direction, and a bottomed hole which opens in the first electrically conductive surface, a second electrical conductor including a second electrically conductive surface opposing the first electrically conductive surface and including a throughhole which overlaps the hole when viewed from a direction perpendicular or substantially perpendicular to the second electrically conductive surface, and a ridge-shaped waveguide protruding from the second electrically conductive surface and extending along the first direction. The waveguide includes an electrically-conductive waveguide surface opposing the first electrically conductive surface, and the waveguide is split into a first ridge and a second ridge having a smaller dimension along the first direction than the first ridge via a gap which overlaps the hole and the throughhole when viewed from a direction perpendicular or substantially perpendicular to the second electrically conductive surface. The waveguide device further includes a plurality of electrically conductive rods which are located around the waveguide, each of the plurality of electrically conductive rods includes a root that is connected to the second electrically conductive surface and a leading end that is opposed to the first electrically conductive surface. The waveguide device also includes a coaxial cable that is partly accommodated in the throughhole and includes a core that is located inside the gap and the hole, such that an electrical insulator or a gap is provided between the core and an inner peripheral surface of the hole.

With the techniques according to the present disclosure, transmission characteristics of a connecting section between the core of a coaxial cable or the like and a waveguide are able to be stabilized.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1A is a schematic cross-sectional view of a connection structure between a WRG and a coaxial cable according to an illustrative first example embodiment of the present disclosure.

FIG. 1B is a schematic plan view of a connection structure between a WRG and a coaxial cable according to the illustrative first example embodiment of the present disclosure.

FIG. 2A is a schematic cross-sectional view of a connection structure between a WRG and a coaxial cable according to an illustrative second example embodiment of the present disclosure.

FIG. 2B is a schematic plan view of a connection structure between a WRG and a coaxial cable according to the illustrative second example embodiment of the present disclosure.

FIG. 2C is a schematic plan view showing a connection structure between a WRG and a coaxial cable according to a variant of the illustrative second example embodiment of the present disclosure.

FIG. 2D is a schematic cross-sectional view of a connection structure between a WRG and a coaxial cable according to another variant of the illustrative second example embodiment of the present disclosure.

FIG. 3 is a schematic cross-sectional view of a connection structure between a WRG and a coaxial cable according to still another variant of the illustrative second example embodiment of the present disclosure.

FIG. 4 is a schematic cross-sectional view showing a connection structure between a WRG and a coaxial cable according to an illustrative third example embodiment of the present disclosure.

FIG. 5 is a schematic cross-sectional view showing a connection structure between a WRG and a coaxial cable according to an illustrative fourth example embodiment of the present disclosure.

FIG. 6A is a schematic cross-sectional view showing a connection structure between a WRG and a coaxial cable according to an illustrative fifth example embodiment of the present disclosure.

FIG. 6B is a schematic cross-sectional view showing a connector for a coaxial cable to be connected to a WRG in the illustrative fifth example embodiment of the present disclosure.

FIG. 6C is a schematic cross-sectional view of the illustrative fifth example embodiment of the present disclosure, with the coaxial cable and the connector being detached.

FIG. 7A is a plan view of the illustrative fifth example embodiment of the present disclosure, where a throughhole and the coaxial cable are viewed from a direction perpendicular to the waveguide face.

FIG. 7B is a plan view of a variant of the illustrative fifth example embodiment of the present disclosure, where a throughhole and the coaxial cable are viewed from a direction perpendicular to the waveguide face.

FIG. 8A is a schematic cross-sectional view showing a connection structure between a WRG and a coaxial cable according to an illustrative sixth example embodiment of the present disclosure.

FIG. 8B is a plan view of the illustrative sixth example embodiment of the present disclosure, where a throughhole and the coaxial cable are viewed from a direction perpendicular to the waveguide face.

FIG. 8C is a schematic cross-sectional view showing a connection structure between a WRG and a coaxial cable according to a variant of the illustrative sixth example embodiment of the present disclosure.

FIG. 8D is a plan view of the variant of the illustrative sixth example embodiment of the present disclosure, where a throughhole and the coaxial cable are viewed from a direction perpendicular to the waveguide face.

FIG. 8E is an enlarged view of a solder portion in a schematic cross section of a connection structure between a WRG and a coaxial cable according to the variant of the illustrative sixth example embodiment of the present disclosure.

FIG. 8F is a plan view of another variant of the illustrative sixth example embodiment of the present disclosure, where a throughhole and the coaxial cable are viewed from a direction perpendicular to the waveguide face.

FIG. 9A is a schematic cross-sectional view showing a connection structure between a WRG and a coaxial cable according to an illustrative seventh example embodiment of the present disclosure.

FIG. 9B is a schematic cross-sectional view of the illustrative seventh example embodiment of the present disclosure, with the coaxial cable and the connector being detached.

FIG. 10 is a schematic cross-sectional view showing a connection structure between a WRG and a coaxial cable according to an illustrative eighth example embodiment of the present disclosure.

FIG. 11 is a perspective view schematically showing a non-limiting example of a fundamental construction of an example embodiment of a waveguide device of the present disclosure.

FIG. 12A is a diagram schematically showing a cross-sectional construction of a waveguide device 100 according to an example embodiment of the present disclosure as taken in parallel to the XZ plane.

FIG. 12B is a diagram schematically showing another cross-sectional construction of the waveguide device 100 as taken in parallel to the XZ plane.

FIG. 13 is a perspective view schematically showing the waveguide device 100, illustrated so that the spacing between a conductive member 110 and a conductive member 120 is exaggerated for ease of understanding.

FIG. 14 is a diagram showing an exemplary range of dimension of each member in the structure shown in FIG. 12A.

FIG. 15A is a cross-sectional view showing a structure according to an example embodiment of the present disclosure in which only a waveguide face 122a (which is an upper face) of the waveguide member 122 is electrically conductive, while remaining portions of the waveguide member 122 other than the waveguide face 122a are not electrically conductive.

FIG. 15B is a diagram showing a variant of an example embodiment in which the waveguide member 122 is not formed on the conductive member 120.

FIG. 15C is a diagram showing an example structure where the conductive member 120, the waveguide member 122, and each of the plurality of conductive rods 124 are composed of a dielectric surface that is coated with an electrically conductive material such as a metal.

FIG. 15D is a diagram showing an example structure in which dielectric layers 110b and 120b are provided on the outermost surface of the conductive members 110 and 120, the waveguide member 122, and each of the conductive rods 124.

FIG. 15E is a diagram showing another example structure in which dielectric layers 110b and 120b are provided on the outermost surface of the conductive members 110 and 120, the waveguide member 122, and each of the conductive rods 124.

FIG. 15F is a diagram showing an example where the height of the waveguide member 122 is lower than the height of the conductive rods 124, and the portion of the conductive surface 110a of the conductive member 110 that is opposed to the waveguide face 122a protrudes toward the waveguide member 122.

FIG. 15G is a diagram showing an example where, further in the structure of FIG. 15F, portions of the conductive surface 110a that are opposed to the conductive rods 124 protrude toward the conductive rods 124.

FIG. 16A is a diagram showing an example where a conductive surface of the conductive member 110 is shaped as a curved surface.

FIG. 16B is a diagram showing an example where also a conductive surface 120a of the conductive member 120 is shaped as a curved surface.

FIG. 17A is a diagram schematically showing an electromagnetic wave that propagates in a narrow space, i.e., a gap between the waveguide face 122a of the waveguide member 122 and the conductive surface 110a of the conductive member 110.

FIG. 17B is a diagram schematically showing a cross section of a hollow waveguide according to an example embodiment of the present disclosure.

FIG. 17C is a cross-sectional view showing an implementation according to an example embodiment of the present disclosure where two waveguide members 122 are provided on the conductive member 120.

FIG. 17D is a diagram schematically showing a cross section of a waveguide device according to an example embodiment of the present disclosure in which two hollow waveguides are placed side-by-side.

FIG. 18A is a perspective view schematically showing a portion of the construction of a slot antenna array 200 utilizing a WRG structure according to an example embodiment of the present disclosure.

FIG. 18B is a diagram schematically showing a portion of a cross-sectional construction as taken parallel to an XZ plane which passes through the centers of two adjacent slots 112 along the X direction of the slot antenna array 200.

FIG. 19 is a perspective view schematically showing a portion of the construction of a slot antenna array 300 according to another example embodiment of the present disclosure.

FIG. 20A is a plan view showing a portion of the construction of the slot antenna array 300.

FIG. 20B is a cross-sectional view showing a portion of the construction of the slot antenna array 300.

FIG. 20C is a plan view showing the structure on the conductive member 120 in the slot antenna array 300.

FIG. 20D is a plan view showing the structure on the conductive member 140 in the slot antenna array 300.

### DETAILED DESCRIPTION

A waveguide device according to an example embodiment of the present disclosure includes a first electrically conductive member, a second electrically conductive member, a waveguide member, a plurality of electrically conductive rods, and a core. The first electrically conductive member includes a first electrically conductive surface having an expanse along a first direction and a second direction which intersects the first direction. The second electrically conductive member includes a second electrically conductive surface opposing the first electrically conductive surface and a throughhole. The waveguide member has a ridge-like structure protruding from the second electrically conductive surface and extending along the first direction. The waveguide member includes an electrically-conductive waveguide face opposing the first electrically conductive surface, and is split into a first ridge which overlaps the throughhole when viewed from a direction perpendicular to the waveguide face and a second ridge having a smaller dimension along the first direction than does the first ridge. The plurality of electrically conductive rods are located around the waveguide member, each having a root that is connected to the second electrically conductive surface and a leading end that is opposed to the first electrically conductive surface. The core is partly accommodated in the throughhole, and is connected to an end face of the first ridge opposing an end face of the second ridge via the gap or connected to that end face of the second ridge.

In the above construction, the “core” or “center core” may be a core of a coaxial cable, or a core of a connector to which a coaxial cable is connected, for example. Connection between the end face of the first ridge or second ridge and the core may be achieved by any arbitrary method, e.g., soldering, for example. The plurality of electrically conductive rods may be located around the first ridge, the second ridge, and the core.

A waveguide is defined between the first ridge and the first electrically conductive member. In the present specification, this waveguide is referred to as a “waffle iron ridge waveguide” (WRG), or simply a “ridge waveguide”. According to an example embodiment of the present disclosure, transmission characteristics at a connecting section between the core and the ridge waveguide can be stabilized.

The waveguide device may further comprise a connector at least a leading end of which is accommodated in the throughhole. The core may be fixed to the second electrically conductive member via the connector.

A leading end of the core may be in contact with the end face of the first ridge or the end face of the second ridge. Alternatively, a portion other than the leading end of the core may be in contact with the end face of the first ridge, or the end face of the second ridge.

The end face of the first ridge or the end face of the second ridge may include a protrusion. Along a height direction of the waveguide member, the protrusion is located between the waveguide face and a root of the waveguide member. The core may be connected to the protrusion.

Regarding the end face of the first ridge or the end face of the second ridge, the protrusion may have a face which is located at an end that is closer to the waveguide face and which is continuous with the waveguide face. Alternatively, regarding the end face of the first ridge or the end face of the second ridge, the protrusion may be located at a position which is distant from both of the waveguide face and the second electrically conductive surface.

Regarding the end face of the first ridge and the end face of the second ridge, the end face that is not connected to the core may have a stepped portion or a slope.

The second electrically conductive member may have a recess surrounding the throughhole in the second electrically conductive surface. The throughhole may open at a bottom of the recess.

A choke structure may be constructed by: a row of one or more electrically conductive rods among the plurality of electrically conductive rods that are adjacent to the second ridge along the first direction; and the second ridge.

When an electromagnetic wave having a center frequency of an operating frequency band of the waveguide device has a wavelength of λo in free space, a dimension of the second ridge along the first direction may be set to a value which is greater than λo/16 and smaller than λo/2.

A waveguide device according to another example embodiment of the present disclosure includes a first electrically conductive member, a second electrically conductive member, a waveguide member, a plurality of electrically conductive rods, and a coaxial cable. The first electrically conductive member includes a first electrically conductive surface having an expanse along a first direction and a second direction which intersects the first direction, and a bottomed hole which opens in the first electrically conductive surface. The second electrically conductive member includes a second electrically conductive surface opposing the first electrically conductive surface and a throughhole which overlaps the hole when viewed from a direction perpendicular to the second electrically conductive surface. The waveguide member has a ridge-like structure protruding from the second electrically conductive surface and extending along the first direction. The waveguide member includes an electrically-conductive waveguide face opposing the first electrically conductive surface. The waveguide member is split into a first ridge and a second ridge having a smaller dimension along the first direction than does the first ridge via a gap which overlaps the hole and the throughhole when viewed from a direction perpendicular to the second electrically conductive surface. The plurality of electrically conductive rods are located around the waveguide member, each having a root that is connected to the second electrically conductive surface and a leading end that is opposed to the first electrically conductive surface. The coaxial cable is partly accommodated in the throughhole. The coaxial cable has a core that is located inside the gap and the hole. An electrical insulator or a gap exists between the core and an inner peripheral surface of the hole.

A waveguide device according to another example embodiment of the present disclosure includes a first electrically conductive member, a second electrically conductive member, a waveguide member, a plurality of electrically conductive rods, and a coaxial cable. The first electrically conductive member includes a first electrically conductive surface having an expanse along a first direction and a second direction which intersects the first direction, and a bottomed hole which opens in the first electrically conductive surface. The second electrically conductive member includes a second electrically conductive surface opposing the first electrically conductive surface and a first throughhole which overlaps the hole when viewed from a direction perpendicular to the second electrically conductive surface. The waveguide member has a ridge-like structure protruding from the second electrically conductive surface and extending along the first direction. The waveguide member includes an electrically-conductive waveguide face opposing the first electrically conductive surface. The waveguide member includes a second throughhole which overlaps the hole and the first throughhole when viewed from a direction perpendicular to the second electrically conductive surface. The plurality of electrically conductive rods are located around the waveguide member, each having a root that is connected to the second electrically conductive surface and a leading end that is opposed to the first electrically conductive surface. The coaxial cable is partly accommodated in the first throughhole and the second throughhole. The coaxial cable has a core that is located inside the first throughhole, the second throughhole, and the hole. An electrical insulator or a gap exists between the core and an inner peripheral surface of the hole.

Hereinafter, example embodiments of the present disclosure will be described more specifically. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

### First Example Embodiment

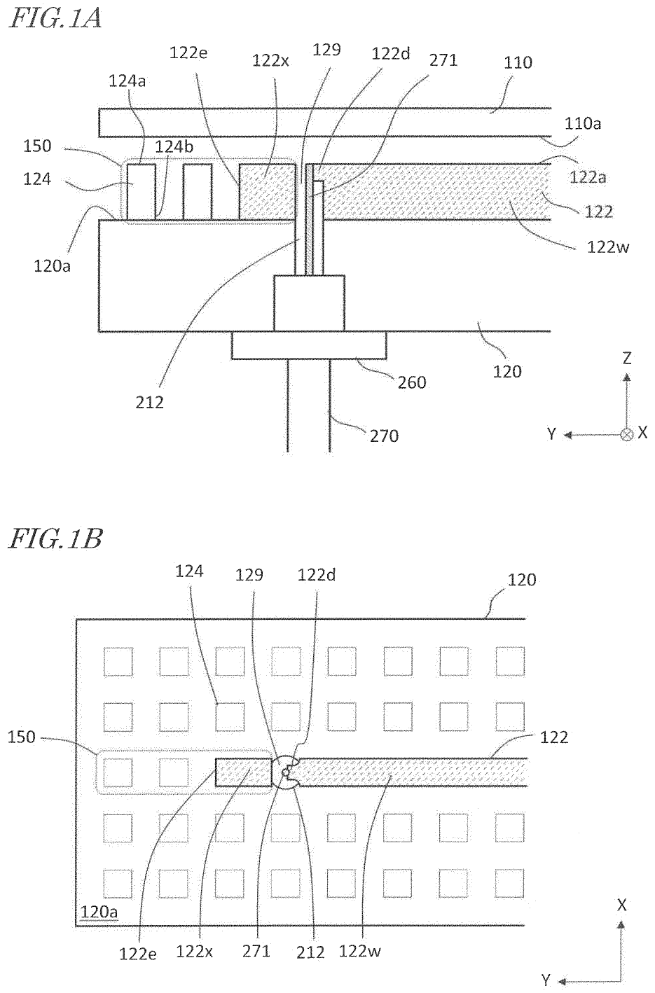

An illustrative first example embodiment of the present disclosure will be described with reference to FIG. 1A and FIG. 1B. FIG. 1A and FIG. 1B show XYZ coordinates along X, Y and Z directions which are orthogonal to one another. Hereinafter, the construction according to any example embodiment of the present disclosure will be described by using this coordinate system. Note that any structure appearing in a figure of the present application is shown in an orientation that is selected for ease of explanation, which in no way should limit its orientation when an example embodiment of the present disclosure is actually practiced. Moreover, the shape and size of a whole or a part of any structure that is shown in a figure should not limit its actual shape and size.

As shown in FIG. 1A, a waveguide device according to the present example embodiment includes a first electrically conductive member 110, a second electrically conductive member 120, and a waveguide member 122 and a plurality of electrically conductive rods 124 that are disposed on the second electrically conductive member 120. Each of the first electrically conductive member 110 and the second electrically conductive member 120 has a plate shape or a block shape. The first electrically conductive member 110 includes, on the side where the second electrically conductive member 120 is located, a conductive surface 110a having an expanse along a first direction and a second direction which intersects the first direction. The second electrically conductive member 120 has a conductive surface 120a opposing the conductive surface 110a of the first electrically conductive member 110. Hereinafter, the conductive surface 110a of the first electrically conductive member 110 may be referred to as the “first conductive surface 110a”, and the conductive surface 120a of the second electrically conductive member 120 as the “second conductive surface 120a”. In the present example embodiment, the Y direction in the coordinate system shown in FIG. 1A corresponds to the “first direction”, and the X direction to the “second direction”.

The waveguide device according to the present example embodiment further includes a connector 260 and a coaxial cable 270. The coaxial cable 270 is to be connected to the waveguide device via the connector 260. The second conductive member 120 has a throughhole 212 for allowing the connector 260 to be attached. At an opposite surface to the conductive surface 120a, the connector 260 is attached to the second conductive member 120. At least a leading end of the connector 260 is accommodated in the throughhole 212.

The waveguide member 122 has a ridge-like structure protruding from the conductive surface 120a of the second conductive member 120. The waveguide member 122 has a structure extending along the first direction (which in the present example embodiment is the Y direction). The waveguide member 122 has an electrically-conductive waveguide face 122a (which may also be referred to as the top face) opposing the first conductive surface 110a. The waveguide face 122a has a stripe shape extending along the Y direction. Without being limited to a linearly extending structure, the waveguide member 122 may also have a structure extending in the shape of a curve. The waveguide member 122 may have one or more bends or branching portions. The gap between the waveguide face 122a of the waveguide member 122 and the first conductive surface 110a defines a waveguide. This waveguide corresponds to the waffle iron ridge waveguide (WRG) which will be described below. One or more recesses and/or one or more protrusions may be provided on the waveguide face 122a. Such a recess(s) and protrusion(s) may be provided for the purpose of adjusting the phase of an electromagnetic wave propagating along the waveguide face 122a.

The waveguide member 122 is split into a first ridge 122w and a second ridge 122x, via a gap 129 which overlaps the throughhole 212 when viewed from a direction perpendicular to the waveguide face 122a. Along the Y direction, the second ridge 122x has a smaller dimension than does the first ridge 122w.

As shown in FIG. 1B, the plurality of conductive rods 124 are arranged along the waveguide member 122. Each conductive rod 124 has a root 124b that is connected to the second conductive surface 120a and a leading end 124a that is opposed to the first conductive surface 110a. In the present example embodiment, the plurality of conductive rods 124 are arranged in a periodic array. Alternatively, the plurality of conductive rods 124 may be arranged aperiodically. The plurality of conductive rods 124 function as an artificial magnetic conductor, as will be described later. In other words, the plurality of conductive rods 124 suppress leakage of an electromagnetic wave propagating through a waveguide that is created in a gap between the waveguide face 122a of the waveguide member 122 and the first conductive surface 110a. So long as this function is fulfilled, the plurality of conductive rods 124 may be arranged in any arbitrary manner. Although the present example embodiment illustrates each conductive rod 124 as having a rectangular solid shape, it may have any other shape. For example, the shape of each rod 124 may be a prismatic shape, a cylindrical shape, frustum of a cone, a frustum of a pyramid, or the like. Each rod 124 may be arranged so that its width along the X direction or the Y direction increases from the leading end 124a toward the root 124b.

Now, let the wavelength in free space of an electromagnetic wave that has a center frequency in the operating frequency band of the waveguide device be λo. The waveguide member 122 is split into two portions at a position of approximately λo/4 from its leading end 122e. Between them, the portion that is closer to the leading end, i.e., the shorter portion, is the second ridge 122x. Since the second ridge 122x also functions as a portion of a choke structure 150, the second ridge 122x is also referred to as the “choke ridge 122x”. Together with one or more rods 124 that are located beyond the leading end 122e, the choke ridge 122x constitutes the choke structure 150. In other words, the choke structure 150 includes a row of one or more conductive rods 124 that are adjacent to the choke ridge 122x along the Y direction, as well as the choke ridge 122x. The choke structure 150 may be composed of: an additional transmission line which is approximately λo/4 long; and a row of grooves having a depth of approximately λo/4 or electrically conductive rods having a height of approximately λo/4 that may be disposed at an end of the additional transmission line. The choke structure 150 provides a phase difference of about 180° (Π) between an incident wave and a reflected wave. As a result, leakage of an electromagnetic wave from one end of the waveguide member 122 can be suppressed.

Note that the dimension of the choke ridge (second ridge) 122x as measured along the Y direction may depend on the structure of the waveguide device, without being limited to λo/4. In one example, the dimension of the second ridge along the first direction is greater than λo/16 and smaller than λo/2.

The leading end of the core 271 of the coaxial cable is located in the gap 129 between an end face of the first ridge 122w of the waveguide member 122 and an end face of the choke ridge 122x. In the example of FIG. 1A, the leading end of the core 271 is located at the same height as the waveguide face 122a. The leading end of the core 271 may extend beyond the waveguide face 122a in the +Z direction.

A protrusion 122d exists on the end face of the first ridge 122w of the waveguide member 122. Along the height direction (which in this example is the Z direction) of the waveguide member 122, the protrusion 122d is located between the waveguide face 122a and the root of the waveguide member 122. In the example shown in FIG. 1A, regarding the end face of the first ridge 122w, the protrusion 122d has a face which is located at an end that is closer to the waveguide face 122a and which is continuous with the waveguide face 122a. The leading end of the core 271 is in contact with the protrusion 122d, which is on the end face of the first ridge 122w. The leading end of the core 271 may be fixed to the protrusion 122d by soldering or other methods, for example. Rather than remaining inside the throughhole 212, the leading end of the core 271 reaches above the conductive surface 120a of the second conductive member 120. This facilitates any work of fixing the leading end of the core 271 to the protrusion 122d. Moreover, since the state of fix can be confirmed by visual inspection or with an ordinary optical camera, it is easy to check for insufficient fixing.

The gap 129 is located above the throughhole 212 in the second conductive member 120. This structure can be regarded as a structure resulting from splitting a single waveguide member 122, i.e., a ridge, by the throughhole 212 and the gap 129 that continues therefrom.

No metal wall exists around the leading end of the core 271 or the protrusion 122d. However, as shown in FIG. 1B, the leading end of the core 271 and the protrusion 122d are surrounded by a plurality of rows of conductive rods 124.

The choke structure 150 and the rows of conductive rods 124 prevent leakage of an electromagnetic wave, thus allowing the electromagnetic wave to be led into the WRG. Herein, the WRG is constructed (defined) by: the conductive surface 110a of the first conductive member 110; the waveguide face 122a; and the rows of conductive rods 124 surrounding the waveguide face 122a.

Thus, in the present example embodiment, the first ridge 122w of the waveguide member 122 includes the protrusion 122d at its end face. The core 271 is to be connected to the protrusion 122d. Such structure allows the coaxial cable 270 and the WRG to be easily connected, and makes it possible to maintain stable electrical characteristics.

### Second Example Embodiment

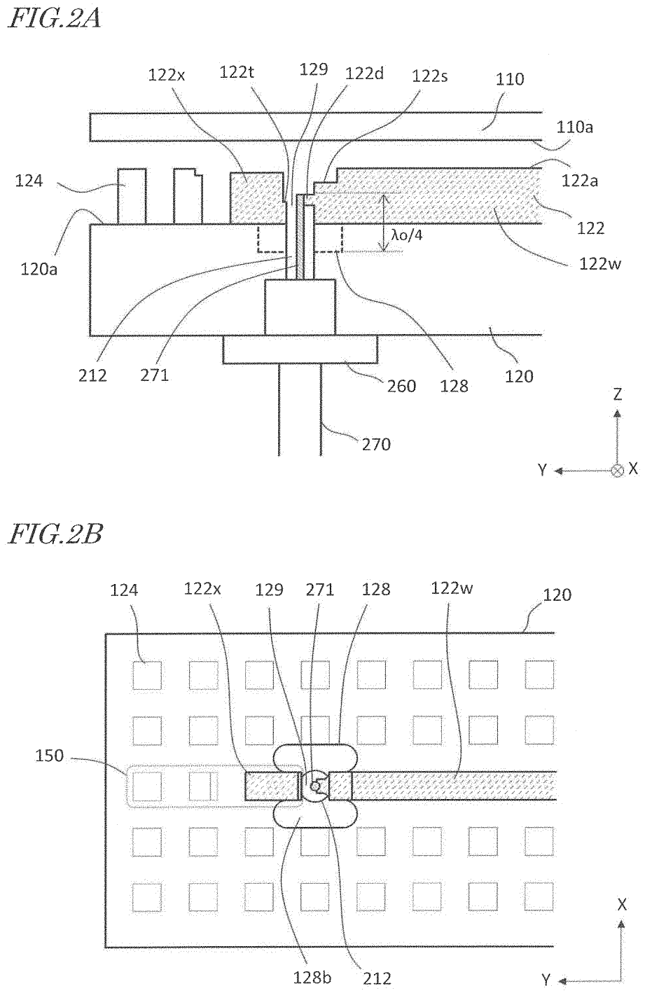

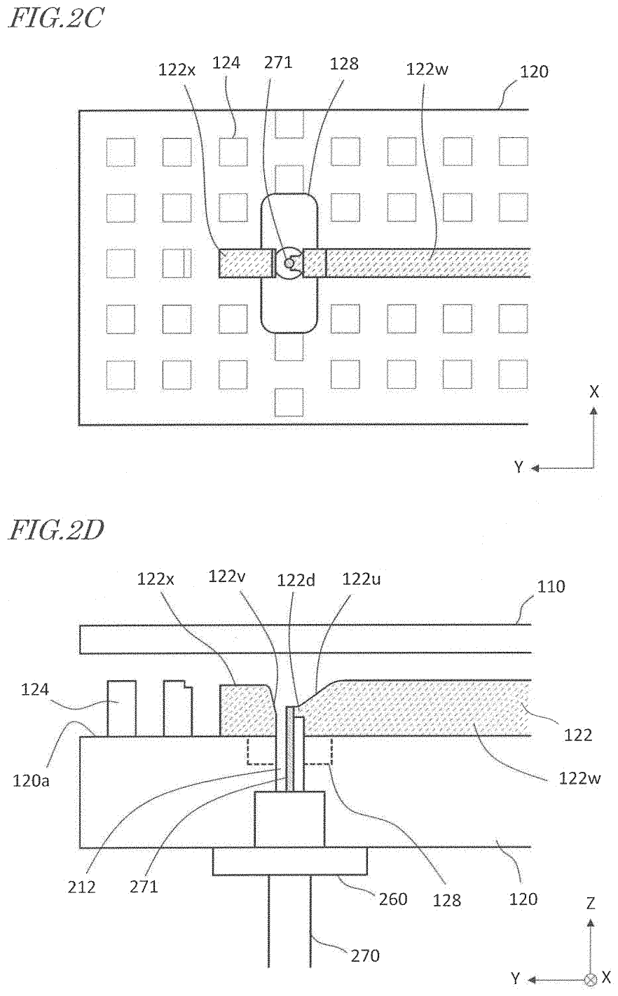

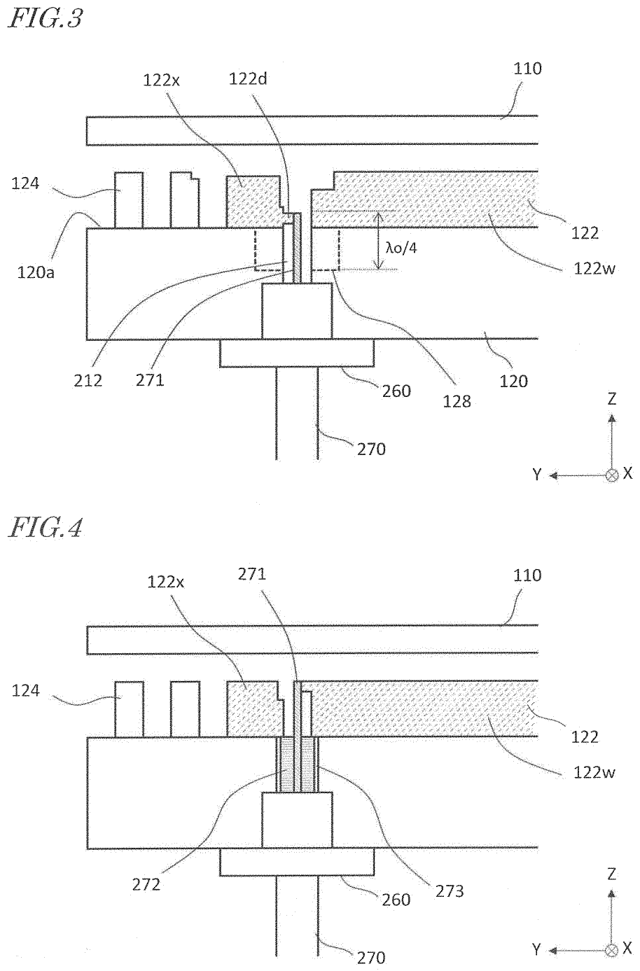

FIG. 2A and FIG. 2B show a waveguide device according to a second example embodiment.

The leading end of a core 271 of the coaxial cable is located in a gap 129 (hereinafter referred to as “the gap 129 of the waveguide member 122”) between an end face of the choke ridge 122x and an end face of the first ridge 122w. A protrusion 122d in the present example embodiment is located at a position which is distant from both of the waveguide face 122a and the second conductive surface 120a, regarding the end face of the first ridge 122w. In the illustrated example, the protrusion 122d is located at an intermediate height between the waveguide face 122a and the conductive surface 120a of the second conductive member 120. The leading end of the core 217 is in contact with the protrusion 122d.

In the second conductive surface 120a, the second conductive member 120 has a recess 128 which surrounds the throughhole 212. The recess 128 has an H shape resembling the alphabetical letter H in plan view. Stated otherwise, in plan view, the recess 128 includes a lateral portion extending along the X direction and a pair of vertical portions extending along the Y direction from both ends of the lateral portion. As shown in FIG. 2B, in plan view, the lateral portion of the H-shape recess 128 overlaps the gap 129 of the waveguide member 122.

The recess 128 has a bottom face 128b such that, in this example, the dimension from the bottom face 128b to the leading end of the core 271 is λo/4. This dimension may have a tolerance of about ±λo/8 from λo/4.

By providing the recess 128, reflection associated with exchanges of electromagnetic waves between the coaxial cable 270 and the WRG is suppressed.

At a portion adjoining the protrusion 122d, the waveguide member 122 has a structure including a stepped portion 122s. Moreover, the choke ridge 122x also has a structure including a stepped portion 122t at its side closer to the gap 129. With these step structures, reflection associated with exchanges of electromagnetic waves between the coaxial cable 270 and the WRG is further suppressed.

Next, variants of the second example embodiment will be described.

As shown in FIG. 2C, the planar shape of the recess 128 of the second conductive member 120 may be a rectangular shape or a shape resembling an ellipse.

As shown in FIG. 2D, instead of a step structure, the waveguide member 122 may have sloped surfaces. In the example shown in FIG. 2D, the first ridge 122w has a slope 122u, while the second ridge 122x has a slope 122v. With such structure, reflection associated with exchanges of electromagnetic waves between the coaxial cable 270 and the WRG can be suppressed, as is the case with a construction having a stepped portion.

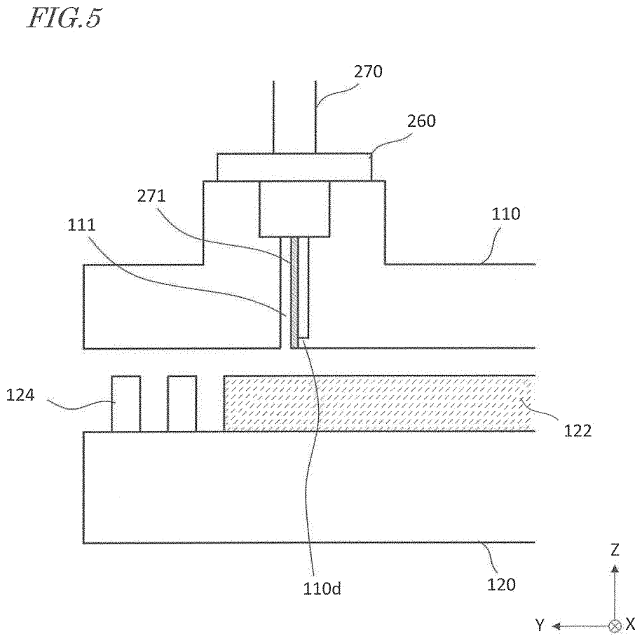

FIG. 3 is a cross-sectional view showing still another variant of the second example embodiment. In this example, an end face of the choke ridge 122x of the waveguide member 122 has a protrusion 122d. The protrusion 122d is at a position close to the conductive surface 120a of the second conductive member 120. The protrusion 122d is located slightly above (i.e., on the +Z side of) the conductive surface 120a of the second conductive member 120. The leading end of the core 271 is in contact with the protrusion 122d of the choke ridge 122x.

The recess 128 in this example is deeper than the recess 128 in the example of FIG. 2A. The dimension of the recess 128 from the bottom face to the leading end of the core 271, as taken along the Z direction, is approximately λo/4, although this is not a limitation. The optimum value of this dimension is subject to various other factors, and may be determined for each given structure.

### Third Example Embodiment

FIG. 4 is a cross-sectional view showing a waveguide device according to a third example embodiment.

In the present example embodiment, the end of the coaxial cable 270 is exposed, in a manner of extending beyond the end of the connector 260. In FIG. 4, only this exposed portion is shown in a cross section. On the inside, the coaxial cable 270 includes a core 271, an electrical insulator 272 covering the core 271, and an external conductor 273 covering the insulator 272. In the present example embodiment, each of the insulator 272 and the external conductor 273 of the coaxial cable 270 is located inside the throughhole 212 of the second conductive member 120. With such structure, too, effects similar to those provided by the aforementioned example embodiment are obtained.

### Fourth Example Embodiment

FIG. 5 is a cross-sectional view showing a waveguide device according to a fourth example embodiment.

In the present example embodiment, a coaxial cable 270 is connected to the WRG from the first conductive member 110 side. It is not the second conductive member 120, but the first conductive member 110, that has a throughhole 111. In the throughhole 111 as such, a connector 260 and a core 271 of the coaxial cable 270 are accommodated. A protrusion 110d exists on the inner wall surface of the throughhole 111 of the first conductive member 110. The leading end of the core 271 is in contact with the protrusion 110d. The waveguide member 122 is not split into two portions. With such structure, too, electromagnetic waves can be propagated between the coaxial cable 270 and the WRG.

### Fifth Example Embodiment

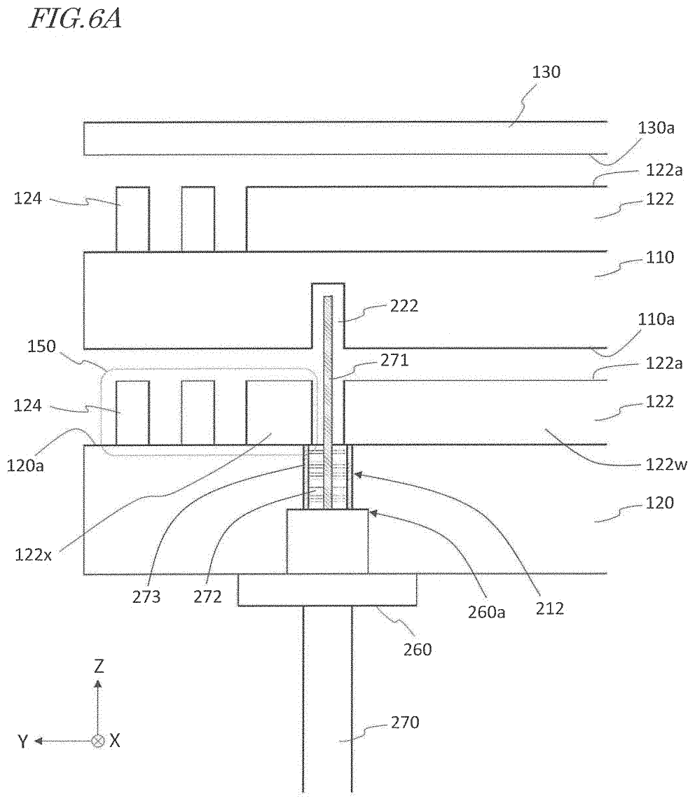

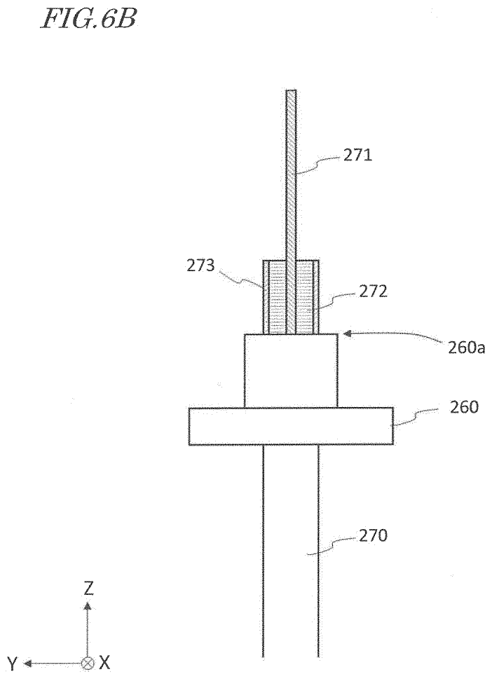

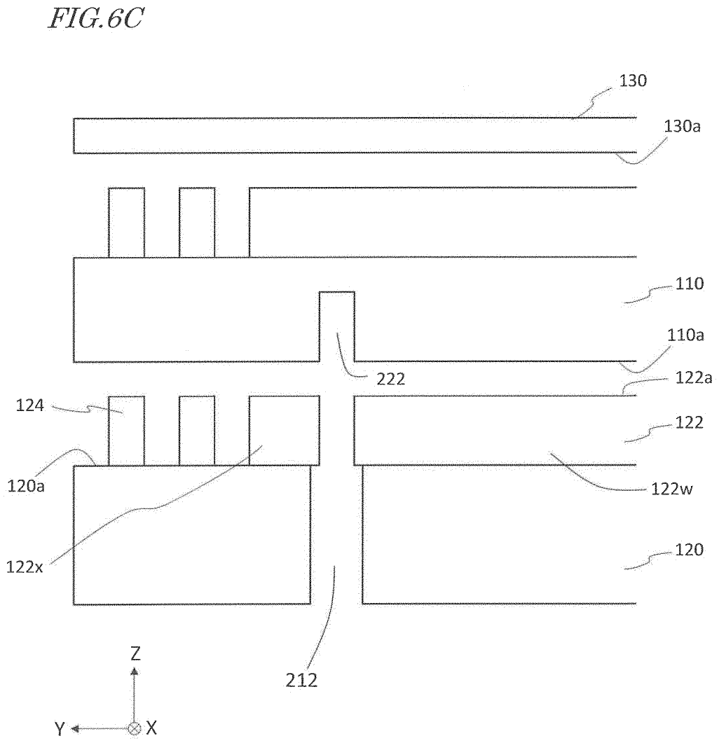

With reference to FIGS. 6A through 6C, a waveguide device according to a fifth example embodiment of the present disclosure will be described. FIG. 6A is a cross-sectional view showing a portion of the structure of the waveguide device according to the present example embodiment. FIG. 6B is a cross-sectional view showing the structure of a coaxial cable 270 for connection with the waveguide device. FIG. 6C is a cross-sectional view showing a portion of the structure resulting after removing the coaxial cable 270 from the waveguide device.

The waveguide device according to the present example embodiment includes a first conductive member 110, a second conductive member 120, and a third conductive member 130, which are layered with gaps therebetween. The first conductive member 110 is located between the second conductive member 120 and the third conductive member 130. A WRG waveguide is created between a conductive surface 110a of the first conductive member 110 and a waveguide face 122a of a waveguide member 122 on the second conductive member 120. Similarly, a WRG waveguide is also created between a waveguide face 122a of a waveguide member 122 on the first conductive member 110 and a conductive surface 130a of the third conductive member 130. These two WRG waveguides are connected to each other via a throughhole (port), not shown, which is made in the first conductive member 110. A plurality of conductive rods 124 are disposed around each waveguide member 122. Note that the waveguide device may not include the third conductive member 130, or the waveguide member 122 and the plurality of conductive rods 124 on the first conductive member 110.

On both sides of each waveguide member 122, a plurality of conductive rods not shown are arranged. A plurality of conductive rods 124 are also arranged beyond the choke ridge 122x of the waveguide member 122 on the second conductive member 120. The conductive rods 124 and the choke ridge 122x constitute a choke structure 150.

The second conductive member 120 has a throughhole 212. A connector 260 is fixed below the throughhole 212. The coaxial cable 270 is to be connected to the connector 260. An end of the coaxial cable 270 is located above the connector 260. In the example of FIG. 6A and FIG. 6B, the end of the coaxial cable 270 is exposed, in a manner of extending beyond an upper end 260a of the connector 260. In FIG. 6A, only this exposed portion is shown in a cross section. An electrical insulator 272 and an external conductor 273 of the coaxial cable 270 extend to the root of the waveguide member 122, but beyond there any portion thereof is removed.

The first conductive member 110 has a bottomed hole 222 which opens in the first conductive surface 110a. When viewed from a direction perpendicular to the first conductive surface 110a or the second conductive surface 120a, the hole 222 and the throughhole 212 overlap each other. A core 271 of the coaxial cable 270 reaches inside the bottomed hole 222. The core 271 is in contact with neither the inner peripheral surface of the gap between the first ridge 122w and the choke ridge 122x nor the inner peripheral surface of the bottomed hole 222. In other words, air or an electrical insulator exists between: the surface of the core 271; and the inner peripheral surface of the gap between the first ridge 122w and the choke ridge 122x, and the inner peripheral surface of the bottomed hole 222. In some cases, a vacuum may exist in each such portion.

The depth of the bottomed hole 222 is set to a depth which will allow a signal wave propagating in the coaxial cable 270 to undergo total reflection. The depth is typically ¼ of a wavelength λo of the signal wave in free space, but is not limited thereto. The optimum depth is subject to various other factors, and may be determined for each given structure.

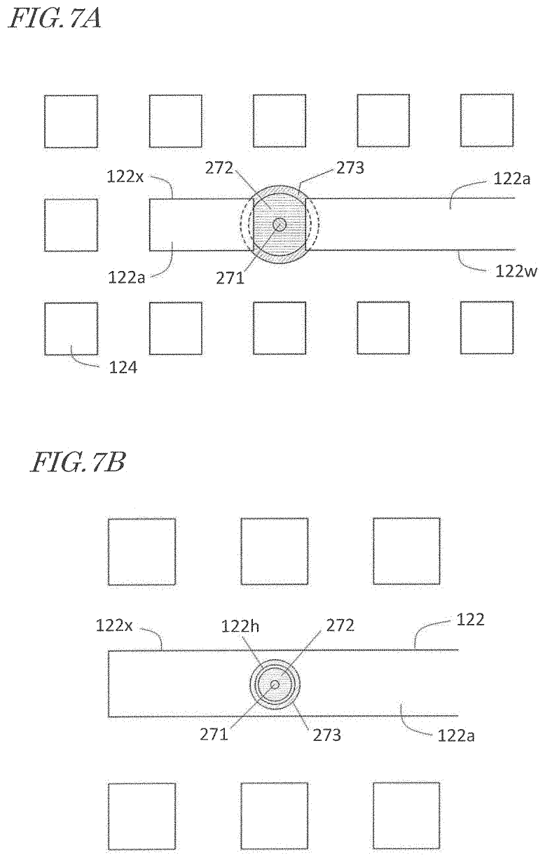

FIG. 7A is a plan view where the structure around the core 271 is viewed from above, along a direction which is perpendicular to the waveguide face 122a shown in FIG. 6A. In this example, the waveguide member 122 and the waveguide face 122a are split by the throughhole 212. The right-side split portion of the waveguide member 122 is the first ridge 122w, whereas the left-side split portion is the second ridge (choke ridge) 122x. The length of the choke ridge 122x along a direction extending along the waveguide face 122a is typically ¼ of the wavelength λg of a signal wave propagating along the WRG, but is not limited thereto. This length is subject to various factors, and may be about ⅛ of λg in some case. In those cases, the choke ridge 122x may apparently have the same structure as a conductive rod 124.

With the above-described structure, a signal wave which has propagated in the coaxial cable 270 is led to the WRG waveguide extending between the first conductive surface 110a and the waveguide face 122a. As shown in FIG. 6A, the choke structure 150 exists on the left of the throughhole 212. Therefore, a signal wave heading in the +Y direction from the throughhole 212 is reflected by the choke structure 150, so as to propagate in the −Y direction.

In the example shown in FIGS. 6A through 6C, the upper end 260a of the connector 260 only reaches a position that is lower than the conductive surface 120a of the second conductive member 120. However, example embodiments of the present disclosure are not limited to such structure. The upper end 260a of the connector 260 may reach the conductive surface 120a of the second conductive member 120. However, it is not preferable for the connector 260 to extend further above and beyond the waveguide face 122a.

Thus, the waveguide device according to the present example embodiment includes the first conductive member 110, the second conductive member 120, the waveguide member 122, the plurality of conductive rods 124, and the coaxial cable 270. The first conductive member 110 includes the first conductive surface 110a having an expanse along a first direction and a second direction which intersects the first direction, and the bottomed hole 222 which opens in the first conductive surface 110a. The second conductive member 120 includes the second conductive surface 120a opposing the first conductive surface 110a, and the throughhole 212 which overlaps the hole 222 when viewed from a direction perpendicular to the second conductive surface 120a. The waveguide member 122 has a ridge-like structure which protrudes from the second conductive surface 120a and extends along the first direction (the Y direction). The waveguide member 122 has the electrically-conductive waveguide face 122a opposing the first conductive surface 110a. The waveguide member 122 is split into the first ridge 122w and the second ridge 122x having a smaller dimension than does the first ridge 122w along the first direction, via a gap which overlaps the hole 222 and the throughhole 212 when viewed from a direction perpendicular to the second conductive surface 120a. The plurality of conductive rods 124 are located around the waveguide member 122. Each of the plurality of conductive rods 124 has a root that is connected to the second conductive surface 120a and a leading end that is opposed to the first conductive surface 110a. The coaxial cable 270 is partly accommodated in the throughhole 212. The coaxial cable 270 includes the core 271 that is located inside the gap and the hole 222. An electrical insulator exists between the core 271 and the inner peripheral surface of the hole 222.

With the structure according to the present example embodiment, too, electromagnetic waves can be suitably transmitted between the coaxial cable 270 and the WRG.

FIG. 7B is a diagram showing a variant of the fifth example embodiment. FIG. 7B is a plan view of the structure around the core 271 as viewed from a direction perpendicular to the waveguide face 122a. In this example, the waveguide member 122 has a throughhole 122h (second throughhole) which overlaps the throughhole 212 (first throughhole) of the second conductive member 120 when viewed from a direction perpendicular to the waveguide face 122a. The diameter of the throughhole 122h is smaller than the width of the waveguide face 122a at least in a portion of the waveguide face 122a. In this example, the waveguide face 122a is not split by the throughholes 212 and 122h. However, also in this case, the portion on the left of the throughhole 212 functions as the choke ridge 122x. In this example, the throughhole 212 of the second conductive member 120 and the throughhole 122h of the waveguide member 122 may be constructed as a single continuous throughhole.

### Sixth Example Embodiment

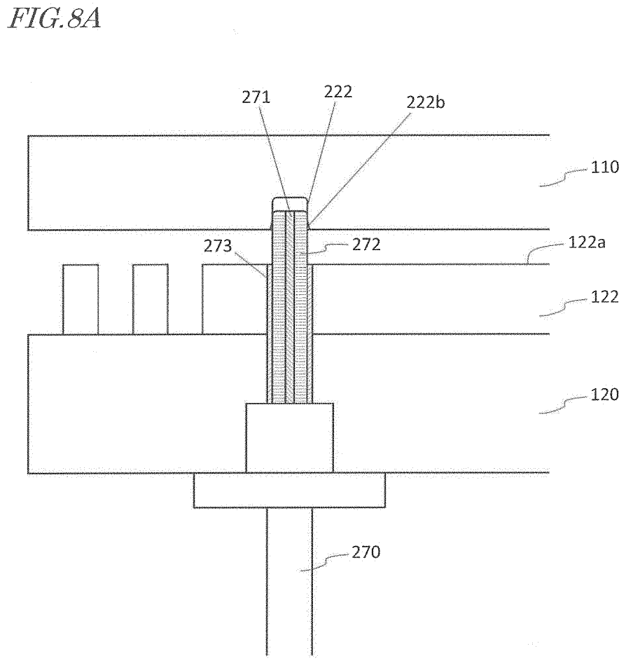

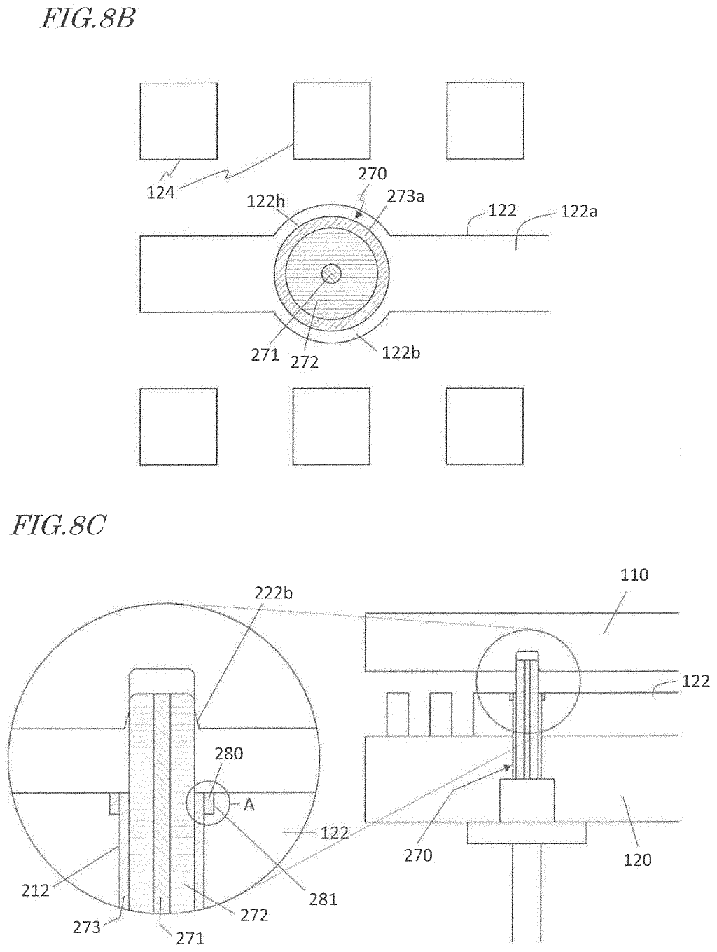

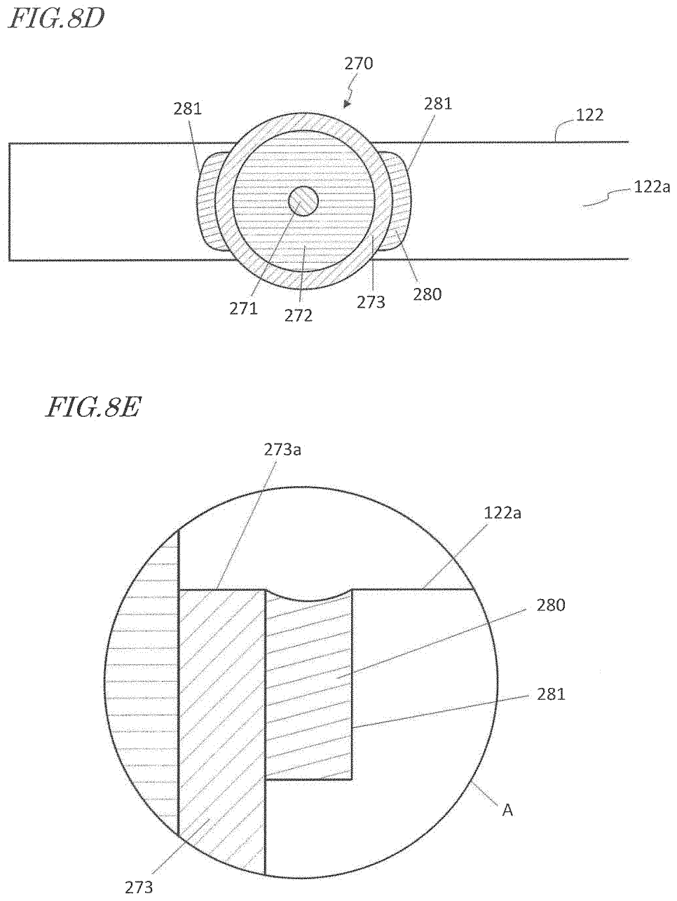

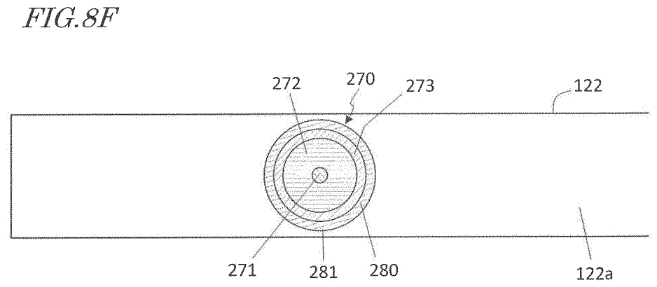

FIG. 8A is a cross-sectional view showing an illustrative sixth example embodiment of the present disclosure. In this example, inside a bottomed hole 222 of the first conductive member 110, an electrical insulator 272 exists between a portion of the surface of the core 271 and a portion of the surface of the bottomed hole 222. By adopting this structure, it becomes easier to keep a constant interval between the surface of the core 271 and the surface of the bottomed hole 222. This means that the exchange of signal waves between the coaxial cable 270 and the WRG is stabilized. The coaxial cable 270 in this example is a semi-rigid type, and includes an external conductor 273 (which is a cylinder made of copper) and the insulator 272 and the core 271 inside it. The external conductor 273 and the waveguide member 122 are in direct electrical contact, and electrical conduction is maintained therebetween.

The electrical insulator 272 may only exist in a portion of the inside of the bottomed hole 222. In that case, too, the aforementioned effects can be obtained. However, as shown in FIG. 8A, the construction in which the root to the leading end of the core 271 is covered by the insulator 272 is easier to produce. The inner peripheral surface of the aperture of the bottomed hole 222 has a sloped surface 222b, with its aperture diameter gently increasing toward the bottom. When the leading end of the insulator 272 is inserted in the hole 222, this sloped surface will guide the leading end along, thus facilitating assembly. The external conductor 273 extends to the position of the waveguide face 122a. In other words, the position of the leading end of the external conductor 273 along the height direction coincides with the position of the waveguide face 122a.

FIG. 8B is a plan view showing the structure around the core 271 according to the sixth example embodiment, as viewed from a direction perpendicular to the waveguide face 122a. The waveguide member 122 has an increased width in a portion thereof, with a throughhole 122h being made in that portion. The waveguide face 122a becomes parted into two directions at the throughhole 122h, thus creating a circular-arc face 122b with a narrow width. An upper end face 273a of the external conductor 273 has the same height as the waveguide faces 122a and 122b, these constituting a substantially continuous surface. Before assembly, the inner diameters of the throughholes 212 and 112h are slightly smaller than the outer diameter of the coaxial cable 270. As such, the coaxial cable 270 being pressed into the throughhole 212 becomes press-fitted in the waveguide member 122. Stated otherwise, before the assembly, the inner diameters of the throughholes 212 and 112h are still smaller than the outer diameter of the coaxial cable 270 on account of the tightening margin associated with press fitting.

FIG. 8C is a cross-sectional view showing a variant of the sixth example embodiment. The difference from the sixth example embodiment is the manner by which the coaxial cable 270 is fixed to the waveguide member 122 or the second conductive member 120: in this variant, soldering is used. Otherwise, it is similar to the sixth example embodiment.

The circle on the left of FIG. 8C shows, enlarged, what is within the circle on the right. The aperture of the throughhole 212 is stepped. The stepped portions function as solder pools 281. Solder 280 is to be provided inside the solder pools 281. The solder 280 connects the outer peripheral surface of the external conductor 273 and the waveguide member 122, thus ensuring electrical conduction between them.

FIG. 8D is a plan view showing the structure around the core 271 of this variant as viewed from a direction perpendicular to the waveguide face 122a. The solder pools 281 are on both sides of the coaxial cable 270. The solder pools 281 do not reach the edge of the waveguide face 122a. Therefore, during soldering, solder can be prevented from flowing out to the side faces of the waveguide member 122.

FIG. 8E is a diagram showing enlarged the portion in circle A in FIG. 8C. It would be ideal for the waveguide face 122a and the upper end face 273a of the external conductor to be aligned in position along the height direction. However, even if they are not aligned in position along the height direction, so long as the difference is smaller than the thickness of the external conductor 273, the difference will be tolerated. It would also be ideal for the upper face of the solder 280 inside the solder pools 281 to be aligned in height with the waveguide face 122a. In actuality, that sort of finish is difficult to achieve, and the upper face of the solder 280 is likely to take either a convex or concave shape; between the two, a concave shape would be more preferable.

FIG. 8F shows another variant of the sixth example embodiment. FIG. 8F is a plan view showing the structure around the core 271 as viewed from a direction perpendicular to the waveguide face 122a. Otherwise, it is similar to the sixth example embodiment.

In this example, the outer diameter of the coaxial cable 270 is smaller than the width of the waveguide face 122a. Also, a solder pool 281 surrounds the entire periphery of the external conductor 273. Since the region to be connected with the solder 280 spans the entire periphery at an end of the external conductor 273, electrical connection between the waveguide member 122 and the external conductor 273 is more securely made.

In the variant shown in FIGS. 8C through 8E and in the other variant shown in FIG. 8F, the coaxial cable 270 is fixed to the waveguide member 122 with the solder 280; however, any other method of fixing may also be used. For example, press fitting and solder fitting may be used in combination.

### Seventh Example Embodiment

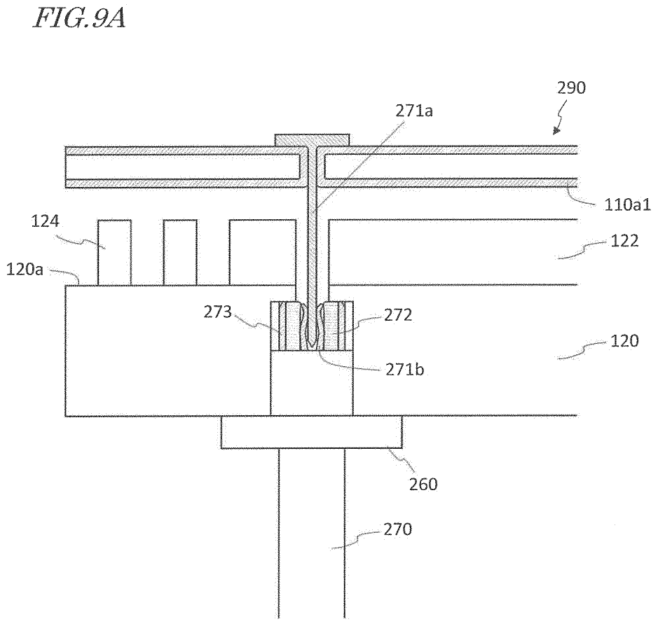

With reference to FIG. 9A and FIG. 9B, an illustrative seventh example embodiment of the present disclosure will be described.

FIG. 9A is a cross-sectional view showing a portion of the structure of a waveguide device according to the present example embodiment. This waveguide device includes a circuit board 290 as a first conductive member. The circuit board 290 is disposed above the second conductive member 120, and covers over the waveguide member 122 and the plurality of conductive rods 124 around it. At least the lower face of the circuit board 290 is covered with a foil of electrical conductor 110al. This lower face functions as a conductive surface of the first conductive member composing a WRG. The surface of the circuit board 290 that is covered by the foil of electrical conductor 110a1 is opposed to the conductive surface 120a of the second conductive member 120, the waveguide face of the waveguide member 122, and the leading end of each conductive rod 124.

A conductor pin 271a extending through the circuit board 290 is fixed to the circuit board 290. The conductor pin 271a extends toward a throughhole in the second conductive member 120. For better conduction, the conductor pin 271a may be soldered to the foil of electrical conductor 110al.

In this example, the connector 260 includes a coupler 271b that is surrounded by the external conductor 273 and the electrical insulator 272. The leading end of the conductor pin 271a is coupled to the coupler 271b, whereby electrical conduction is maintained.

FIG. 9B is a version of FIG. 9A with the connector 260 detached. The conductor pin 271a remains on the waveguide device, even with the connector 260 being detached.

With the construction of the present example embodiment, too, good connection between the coaxial cable 270 and the WRG can be attained, similar to the aforementioned example embodiments.

In each of the example embodiments described above, the connector 260 is detachable from the waveguide device. However, when the reliability of electrical conduction between the external conductor 273 of the coaxial cable and the second conductive member 120 needs to be enhanced, the connector 260 may be fixed to the waveguide device by using soldering or the like.

### Eighth Example Embodiment

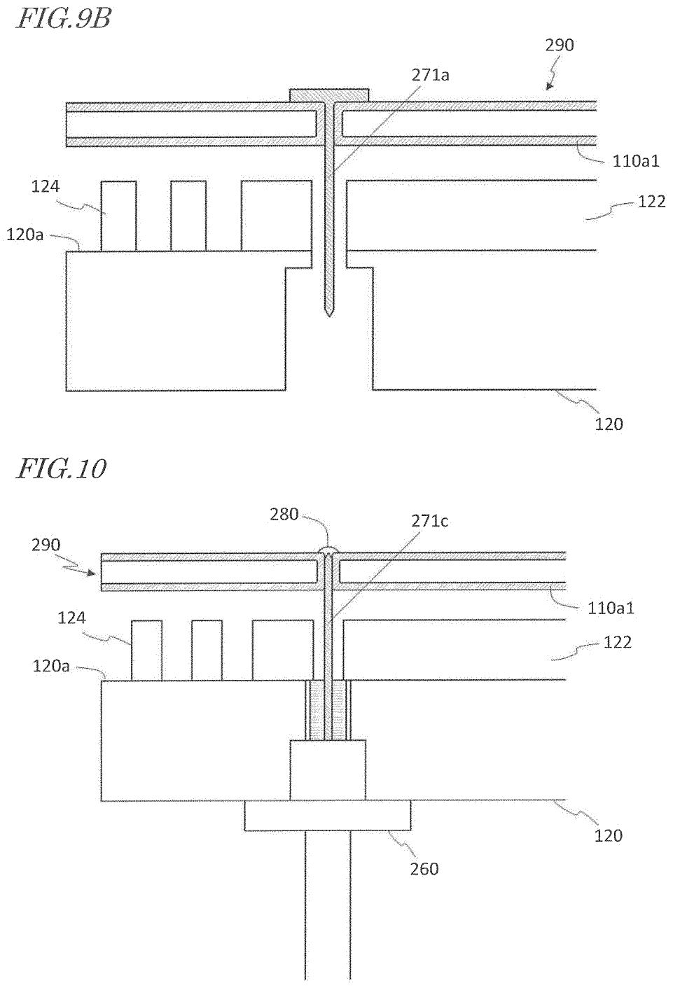

FIG. 10 is a cross-sectional view showing an illustrative eighth example embodiment of the present disclosure. In this example, the connector 260 has an extended core 271c, with its leading end being fixed to a circuit board 290. For better electrical conduction, solder 280 may be used to connect a foil of electrical conductor 110a1 on the circuit board 290 and the core 271c. In this example, the connector 260 is fixed to the waveguide device, and cannot be detached; when there is no need for detachment, this sort of construction may be chosen.

Various coaxial cables may be used in each of the above example embodiments. For stable characteristics, however, a coaxial cable of a semi-rigid type such as that used in the seventh example embodiment is desirable, for example. A coaxial cable of a semi-rigid type features a metal cylinder as an external conductor, thus providing for stable characteristics.

In the meaning of the present specification, a coaxial cable refers to a cable that includes a core, an external conductor (shielding) surrounding the core, and an electrical insulator that is present between the core and the shielding, or any similar structure. Therefore, not only commercially-available coaxial cables themselves, but also any structure that has the aforementioned constituent elements is regarded as a coaxial cable in the present specification. Moreover, the electrically-conductive inner wall surface of the throughhole of the second conductive member may serve as a substitute for the external conductor of a coaxial cable. As the insulator, fluoroplastics or the like may be used, but air may instead be utilized. However, in the case where air is used as the insulator, a separate consideration may be necessary for maintaining the gap between the core and the shielding.

### <Exemplary WRG Construction>

Next, an exemplary construction of a WRG that is used in each example embodiment above will be described in more detail. A WRG is a ridge waveguide that may be provided in a waffle iron structure functioning as an artificial magnetic conductor. Such a ridge waveguide is able to realize an antenna feeding network with low losses in the microwave or the millimeter wave band. Moreover, use of such a ridge waveguide allows antenna elements to be disposed with a high density. Hereinafter, an exemplary fundamental construction and operation of such a waveguide structure will be described.

An artificial magnetic conductor is a structure which artificially realizes the properties of a perfect magnetic conductor (PMC), which does not exist in nature. One property of a perfect magnetic conductor is that “a magnetic field on its surface has zero tangential component”. This property is the opposite of the property of a perfect electric conductor (PEC), i.e., “an electric field on its surface has zero tangential component”. Although no perfect magnetic conductor exists in nature, it can be embodied by an artificial structure, e.g., an array of a plurality of electrically conductive rods. An artificial magnetic conductor functions as a perfect magnetic conductor in a specific frequency band which is defined by its structure. An artificial magnetic conductor restrains or prevents an electromagnetic wave of any frequency that is contained in the specific frequency band (propagation-restricted band) from propagating along the surface of the artificial magnetic conductor. For this reason, the surface of an artificial magnetic conductor may be referred to as a high impedance surface.

For example, a plurality of electrically conductive rods that are arranged along row and column directions may constitute an artificial magnetic conductor. Such rods may be referred to posts or pins. Each of these waveguide devices, as a whole, includes a pair of opposing electrically conductive plates. One of the electrically conductive plates has a ridge that protrudes toward the other electrically conductive plate, and an artificial magnetic conductor that are located on both sides of the ridge. Via a gap, an upper face (which is an electrically-conductive face) of the ridge is opposed to the electrically conductive surface of the other electrically conductive plate. An electromagnetic wave (signal wave) of a wavelength which is contained in the propagation stop band of the artificial magnetic conductor propagates along the ridge, in the space (gap) between this conductive surface and the upper face of the ridge.

FIG. 11 is a perspective view showing a non-limiting example of a fundamental construction of such a waveguide device. The waveguide device 100 shown in the figure includes a plate shape (plate-like) electrically conductive members 110 and 120, which are in opposing and parallel positions to each other. A plurality of electrically conductive rods 124 are arrayed on the conductive member 120.

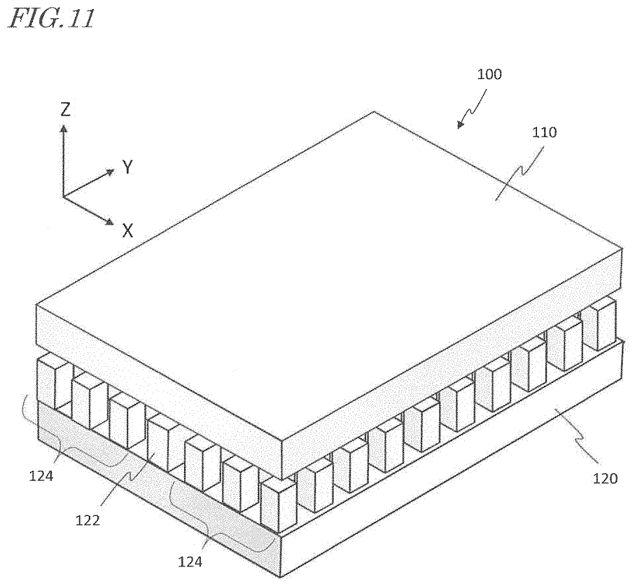

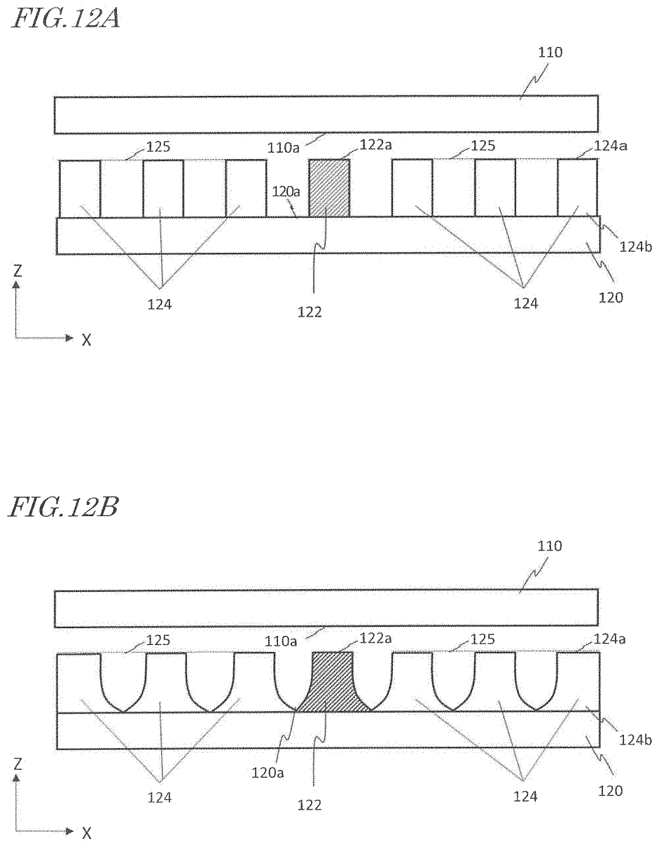

FIG. 12A is a diagram schematically showing a cross-sectional construction of the waveguide device 100 as taken parallel to the XZ plane. As shown in FIG. 12A, the conductive member 110 has an electrically conductive surface 110a on the side facing the conductive member 120. The conductive surface 110a has a two-dimensional expanse along a plane which is orthogonal to the axial direction (i.e., the Z direction) of the conductive rods 124 (i.e., a plane which is parallel to the XY plane). Although the conductive surface 110a is shown to be a smooth plane in this example, the conductive surface 110a does not need to be a plane, as will be described later.

FIG. 13 is a perspective view schematically showing the waveguide device 100, illustrated so that the spacing between the conductive member 110 and the conductive member 120 is exaggerated for ease of understanding. In an actual waveguide device 100, as shown in FIG. 11 and FIG. 12A, the spacing between the conductive member 110 and the conductive member 120 is narrow, with the conductive member 110 covering over all of the conductive rods 124 on the conductive member 120.

FIG. 11 to FIG. 13 only show portions of the waveguide device 100. The conductive members 110 and 120, the waveguide member 122, and the plurality of conductive rods 124 actually extend to outside of the portions illustrated in the figures. At an end of the waveguide member 122, a choke structure for preventing electromagnetic waves from leaking into the external space is provided. The choke structure may include a row of conductive rods that are adjacent to the end of the waveguide member 122, for example.

See FIG. 12A again. The plurality of conductive rods 124 arrayed on the conductive member 120 each have a leading end 124a opposing the conductive surface 110a. In the example shown in the figure, the leading ends 124a of the plurality of conductive rods 124 are on the same plane or on substantially the same plane. This plane defines the surface 125 of an artificial magnetic conductor. Each conductive rod 124 does not need to be entirely electrically conductive, so long as it includes an electrically conductive layer which extends at least along the upper face and the side faces of the rod-like structure. This electrically conductive layer may be located on the surface layer of the rod-like structure; alternatively, the surface layer may be composed of insulation coating or a resin layer, with no electrically conductive layer being present on the surface of the rod-like structure. Moreover, each conductive member 120 does not need to be entirely electrically conductive, so long as it can support the plurality of conductive rods 124 to constitute an artificial magnetic conductor. Of the surfaces of the conductive member 120, a face carrying the plurality of conductive rods 124 may be electrically conductive, such that the electrical conductor electrically interconnects the surfaces of adjacent ones of the plurality of conductive rods 124. The electrically conductive layer of the conductive member 120 may be covered with insulation coating or a resin layer. In other words, the entire combination of the conductive member 120 and the plurality of conductive rods 124 may at least include an electrically conductive layer with rises and falls opposing the conductive surface 110a of the conductive member 110.

On the conductive member 120, a ridge-like waveguide member 122 is provided among the plurality of conductive rods 124. More specifically, stretches of an artificial magnetic conductor are present on both sides of the waveguide member 122, such that the waveguide member 122 is sandwiched between the stretches of artificial magnetic conductor on both sides. As can be seen from FIG. 13, the waveguide member 122 in this example is supported on the conductive member 120, and extends linearly along the Y direction. In the example shown in the figure, the waveguide member 122 has the same height and width as those of the conductive rods 124. As will be described later, however, the height and width of the waveguide member 122 may have respectively different values from those of the conductive rod 124. Unlike the conductive rods 124, the waveguide member 122 extends along a direction (which in this example is the Y direction) in which to guide electromagnetic waves along the conductive surface 110a. Similarly, the waveguide member 122 does not need to be entirely electrically conductive, but may at least include an electrically conductive waveguide face 122a opposing the conductive surface 110a of the conductive member 110. The conductive member 120, the plurality of conductive rods 124, and the waveguide member 122 may be portions of a continuous single-piece body. Furthermore, the conductive member 110 may also be a portion of such a single-piece body.

On both sides of the waveguide member 122, the space between the surface 125 of each stretch of artificial magnetic conductor and the conductive surface 110a of the conductive member 110 does not allow an electromagnetic wave of any frequency that is within a specific frequency band to propagate. This frequency band is called a “prohibited band”. The artificial magnetic conductor is designed so that the frequency of an electromagnetic wave (signal wave) to propagate in the waveguide device 100 (which may hereinafter be referred to as the “operating frequency”) is contained in the prohibited band. The prohibited band may be adjusted based on the following: the height of the conductive rods 124, i.e., the depth of each groove formed between adjacent conductive rods 124; the diameter of each conductive rod 124; the interval between conductive rods 124; and the size of the gap between the leading end 124a and the conductive surface 110a of each conductive rod 124.

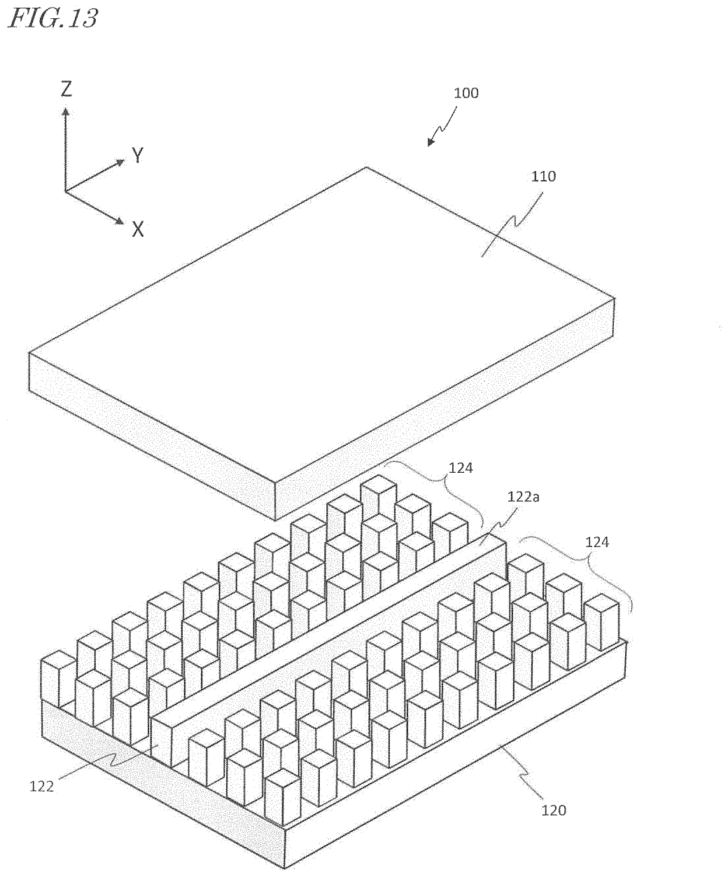

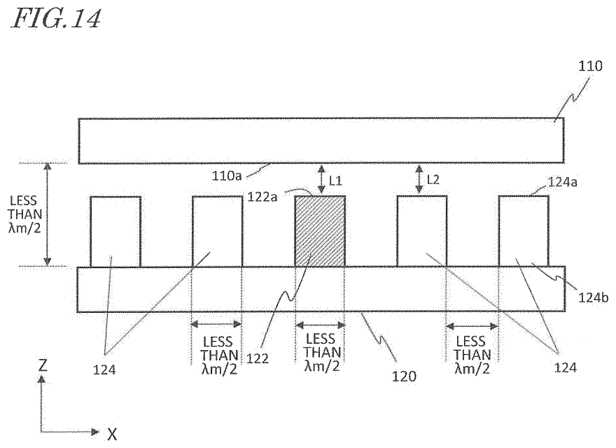

Next, with reference to FIG. 14, the dimensions, shape, positioning, and the like of each member will be described.

FIG. 14 is a diagram showing an exemplary range of dimension of each member in the structure shown in FIG. 12A. The waveguide device is used for at least one of transmission and reception of electromagnetic waves of a predetermined band (referred to as the “operating frequency band”). In the present specification, λo denotes a representative value of wavelengths in free space (e.g., a central wavelength corresponding to a center frequency in the operating frequency band) of an electromagnetic wave (signal wave) propagating in a waveguide extending between the conductive surface 110a of the conductive member 110 and the waveguide face 122a of the waveguide member 122. Moreover, λm denotes a wavelength, in free space, of an electromagnetic wave of the highest frequency in the operating frequency band. The end of each conductive rod 124 that is in contact with the conductive member 120 is referred to as the “root”. As shown in FIG. 14, each conductive rod 124 has the leading end 124a and the root 124b. Examples of dimensions, shapes, positioning, and the like of the respective members are as follows.

### (1) Width of the Conductive Rod

The width (i.e., the size along the X direction and the Y direction) of the conductive rod 124 may be set to less than λm/2. Within this range, resonance of the lowest order can be prevented from occurring along the X direction and the Y direction. Since resonance may possibly occur not only in the X and Y directions but also in any diagonal direction in an X-Y cross section, the diagonal length of an X-Y cross section of the conductive rod 124 is also preferably less than λm/2. The lower limit values for the rod width and diagonal length will conform to the minimum lengths that are producible under the given manufacturing method, but is not particularly limited.

(2) Distance from the Root of the Conductive Rod to the Conductive Surface of the Conductive Member 110

The distance from the root 124b of each conductive rod 124 to the conductive surface 110a of the conductive member 110 may be longer than the height of the conductive rods 124, while also being less than λm/2. When the distance is λm/2 or more, resonance may occur between the root 124b of each conductive rod 124 and the conductive surface 110a, thus reducing the effect of signal wave containment.

The distance from the root 124b of each conductive rod 124 to the conductive surface 110a of the conductive member 110 corresponds to the spacing between the conductive member 110 and the conductive member 120. For example, when a signal wave of 76.5±0.5 GHz (which belongs to the millimeter band or the extremely high frequency band) propagates in the waveguide, the wavelength of the signal wave is in the range from 3.8934 mm to 3.9446 mm. Therefore, λm equals 3.8934 mm in this case, so that the spacing between the conductive member 110 and the conductive member 120 may be designed to be less than a half of 3.8934 mm. So long as the conductive member 110 and the conductive member 120 realize such a narrow spacing while being disposed opposite from each other, the conductive member 110 and the conductive member 120 do not need to be strictly parallel. Moreover, when the spacing between the conductive member 110 and the conductive member 120 is less than λm/2, a whole or a part of the conductive member 110 and/or the conductive member 120 may be shaped as a curved surface. On the other hand, the conductive members 110 and 120 each have a planar shape (i.e., the shape of their region as perpendicularly projected onto the XY plane) and a planar size (i.e., the size of their region as perpendicularly projected onto the XY plane) which may be arbitrarily designed depending on the purpose.

In the example shown in FIG. 12A, the conductive surface 120a is illustrated as a plane; however, example embodiments of the present disclosure are not limited thereto. For example, as shown in FIG. 12B, the conductive surface 120a may be the bottom parts of faces each of which has a cross section similar to a U-shape or a V-shape. The conductive surface 120a will have such a structure when each conductive rod 124 or the waveguide member 122 is shaped with a width which increases toward the root. Even with such a structure, the device shown in FIG. 12B can function as the waveguide device according to an example embodiment of the present disclosure so long as the distance between the conductive surface 110a and the conductive surface 120a is less than a half of the wavelength λm.

(3) Distance L2 from the Leading End of the Conductive Rod to the Conductive Surface

The distance L2 from the leading end 124a of each conductive rod 124 to the conductive surface 110a is set to less than λm/2. When the distance is λm/2 or more, a propagation mode where electromagnetic waves reciprocate between the leading end 124a of each conductive rod 124 and the conductive surface 110a may occur, thus no longer being able to contain an electromagnetic wave. Note that, among the plurality of conductive rods 124, at least those which are adjacent to the waveguide member 122 do not have their leading ends in electrical contact with the conductive surface 110a. As used herein, the leading end of a conductive rod not being in electrical contact with the conductive surface means either of the following states: there being an air gap between the leading end and the conductive surface; or the leading end of the conductive rod and the conductive surface adjoining each other via an insulating layer which may exist in the leading end of the conductive rod or in the conductive surface.

### (4) Arrangement and Shape of Conductive Rods

The interspace between two adjacent conductive rods 124 among the plurality of conductive rods 124 has a width of less than λm/2, for example. The width of the interspace between any two adjacent conductive rods 124 is defined by the shortest distance from the surface (side face) of one of the two conductive rods 124 to the surface (side face) of the other. This width of the interspace between rods is to be determined so that resonance of the lowest order will not occur in the regions between rods. The conditions under which resonance will occur are determined based by a combination of: the height of the conductive rods 124; the distance between any two adjacent conductive rods; and the capacitance of the air gap between the leading end 124a of each conductive rod 124 and the conductive surface 110a. Therefore, the width of the interspace between rods may be appropriately determined depending on other design parameters. Although there is no clear lower limit to the width of the interspace between rods, for manufacturing ease, it may be e.g. λm/16 or more when an electromagnetic wave in the extremely high frequency range is to be propagated. Note that the interspace does not need to have a constant width. So long as it remains less than λm/2, the interspace between conductive rods 124 may vary.

The arrangement of the plurality of conductive rods 124 is not limited to the illustrated example, so long as it exhibits a function of an artificial magnetic conductor. The plurality of conductive rods 124 do not need to be arranged in orthogonal rows and columns; the rows and columns may be intersecting at angles other than 90 degrees. The plurality of conductive rods 124 do not need to form a linear array along rows or columns, but may be in a dispersed arrangement which does not present any straightforward regularity. The conductive rods 124 may also vary in shape and size depending on the position on the conductive member 120.

The surface 125 of the artificial magnetic conductor that are constituted by the leading ends 124a of the plurality of conductive rods 124 does not need to be a strict plane, but may be a plane with minute rises and falls, or even a curved surface. In other words, the conductive rods 124 do not need to be of uniform height, but rather the conductive rods 124 may be diverse so long as the array of conductive rods 124 is able to function as an artificial magnetic conductor.

Each conductive rod 124 does not need to have a prismatic shape as shown in the figure, but may have a cylindrical shape, for example. Furthermore, each conductive rod 124 does not need to have a simple columnar shape. The artificial magnetic conductor may also be realized by any structure other than an array of conductive rods 124, and various artificial magnetic conductors are applicable to the waveguide device of the present disclosure. Note that, when the leading end 124a of each conductive rod 124 has a prismatic shape, its diagonal length is preferably less than λm/2. When the leading end 124a of each conductive rod 124 is shaped as an ellipse, the length of its major axis is preferably less than λm/2. Even when the leading end 124a has any other shape, the dimension across it is preferably less than λm/2 even at the longest position.

The height of each conductive rod 124 (in particular, those conductive rods 124 which are adjacent to the waveguide member 122), i.e., the length from the root 124b to the leading end 124a, may be set to a value which is shorter than the distance (i.e., less than λm/2) between the conductive surface 110a and the conductive surface 120a, e.g., λo/4.

### (5) Width of the Waveguide Face

The width of the waveguide face 122a of the waveguide member 122, i.e., the size of the waveguide face 122a along a direction which is orthogonal to the direction that the waveguide member 122 extends, may be set to less than λm/2 (e.g. λo/8). If the width of the waveguide face 122a is λm/2 or more, resonance will occur along the width direction, which will prevent any WRG from operating as a simple transmission line.

### (6) Height of the Waveguide Member

The height (i.e., the size along the Z direction in the example shown in the figure) of the waveguide member 122 is set to less than λm/2. The reason is that, if the distance is λm/2 or more, the distance between the root 124b of each conductive rod 124 and the conductive surface 110a will be λm/2 or more.

### (7) Distance L1 Between the Waveguide Face and the Conductive Surface

The distance L1 between the waveguide face 122a of the waveguide member 122 and the conductive surface 110a is set to less than λm/2. If the distance is λm/2 or more, resonance will occur between the waveguide face 122a and the conductive surface 110a, which will prevent functionality as a waveguide. In one example, the distance L1 is λm/4 or less. In order to ensure manufacturing ease, when an electromagnetic wave in the extremely high frequency range is to propagate, the distance L1 is preferably λm/16 or more, for example.

The lower limit of the distance L1 between the conductive surface 110a and the waveguide face 122a and the lower limit of the distance L2 between the conductive surface 110a and the leading end 124a of each conductive rod 124 depends on the machining precision, and also on the precision when assembling the two upper/lower conductive members 110 and 120 so as to be apart by a constant distance. When a pressing technique or an injection technique is used, the practical lower limit of the aforementioned distance is about 50 micrometers (μm). In the case of using MEMS (Micro-Electro-Mechanical System) technology to make a product in e.g. the terahertz range, the lower limit of the aforementioned distance is about 2 to about 3 μm.

Next, variants of waveguide structures including the waveguide member 122, the conductive members 110 and 120, and the plurality of conductive rods 124 will be described. The following variants are applicable to the WRG structure in any place in example embodiments of the present disclosure.

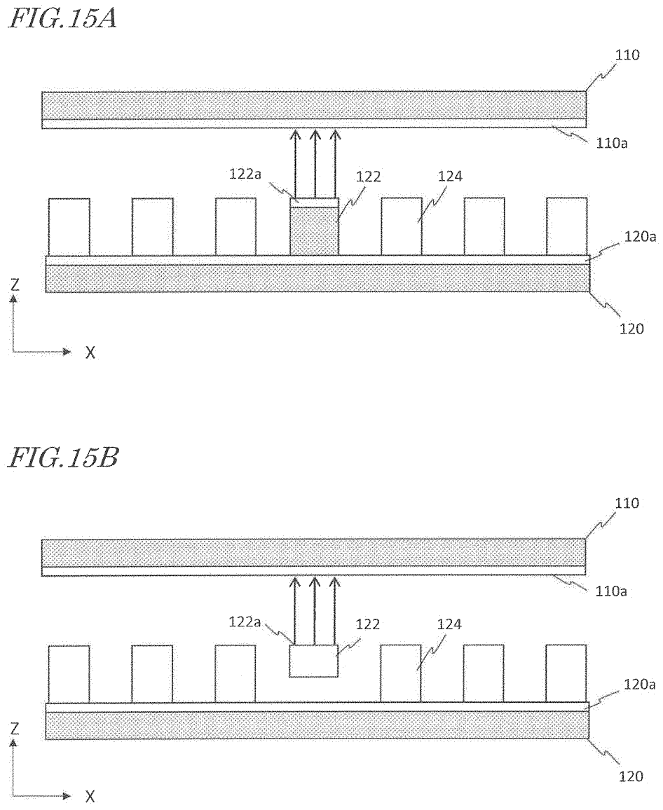

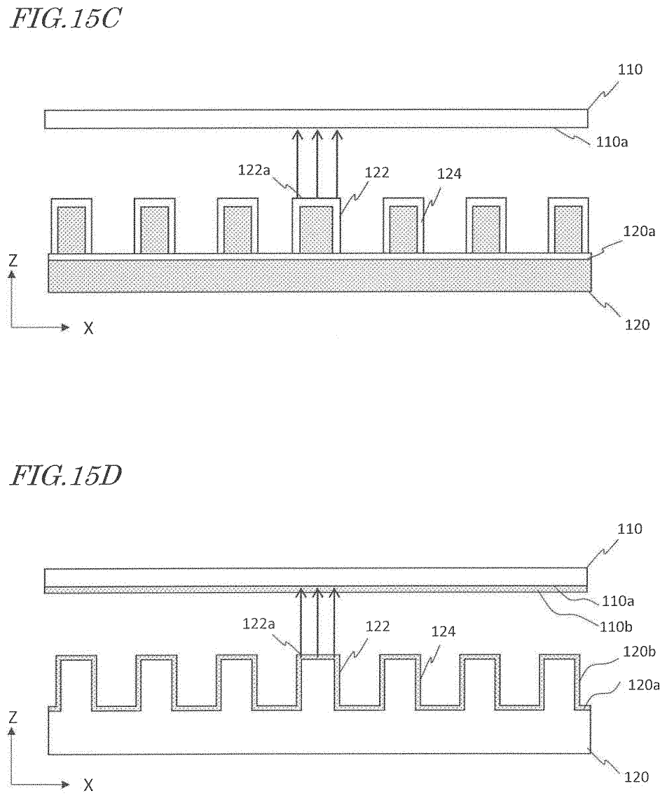

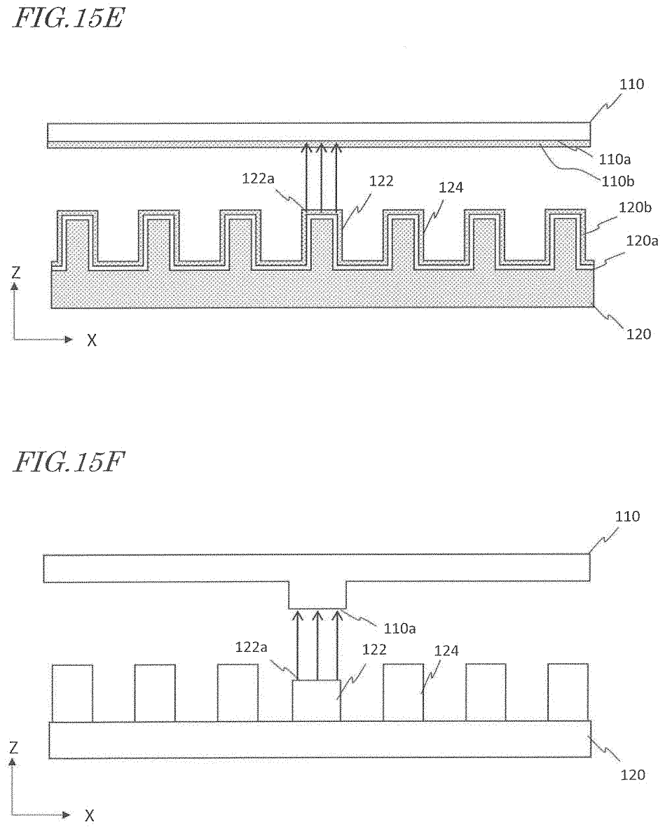

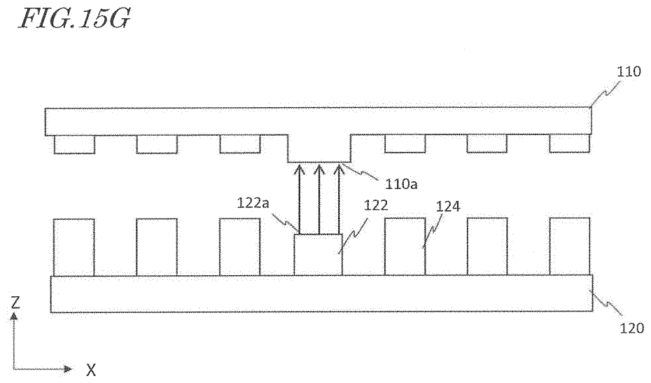

FIG. 15A is a cross-sectional view showing an exemplary structure in which only the waveguide face 122a, defining an upper face of the waveguide member 122, is electrically conductive, while any portion of the waveguide member 122 other than the waveguide face 122a is not electrically conductive. Both of the conductive members 110 and 120 alike are only electrically conductive at their surface that has the waveguide member 122 provided thereon (i.e., the conductive surface 110a, 120a), while not being electrically conductive in any other portions. Thus, each of the waveguide member 122, the conductive member 110, and the conductive member 120 does not need to be electrically conductive.

FIG. 15B is a diagram showing a variant in which the waveguide member 122 is not formed on the conductive member 120. In this example, the waveguide member 122 is fixed to a supporting member (e.g., the inner wall of the housing) that supports the conductive members 110 and 120. A gap exists between the waveguide member 122 and the conductive member 120. Thus, the waveguide member 122 does not need to be connected to the conductive member 120.

FIG. 15C is a diagram showing an exemplary structure where the conductive member 120, the waveguide member 122, and each of the plurality of conductive rods 124 are composed of a dielectric surface that is coated with an electrically conductive material such as a metal. The conductive member 120, the waveguide member 122, and the plurality of conductive rods 124 are connected to one another via the electrical conductor. On the other hand, the conductive member 110 is made of an electrically conductive material such as a metal.

FIG. 15D and FIG. 15E are diagrams each showing an exemplary structure in which dielectric layers 110b and 120b are respectively provided on the outermost surfaces of conductive members 110 and 120, a waveguide member 122, and conductive rods 124. FIG. 15D shows an exemplary structure in which the surface of metal conductive members, which are electrical conductors, are covered with a dielectric layer. FIG. 15E shows an example where the conductive member 120 is structured so that the surface of members which are composed of a dielectric, e.g., resin, is covered with an electrical conductor such as a metal, this metal layer being further coated with a dielectric layer. The dielectric layer that covers the metal surface may be a coating of resin or the like, or an oxide film of passivation coating or the like which is generated as the metal becomes oxidized.

The dielectric layer on the outermost surface will allow losses to be increased in the electromagnetic wave propagating through the WRG waveguide, but is able to protect the conductive surfaces 110a and 120a (which are electrically conductive) from corrosion. It also prevents influences of a DC voltage, or an AC voltage of such a low frequency that it is not capable of propagation on certain WRG waveguides.

FIG. 15F is a diagram showing an example where the height of the waveguide member 122 is lower than the height of the conductive rods 124, and the portion of the conductive surface 110a of the conductive member 110 that is opposed to the waveguide face 122a protrudes toward the waveguide member 122. Even such a structure will operate in a similar manner to the above-described example embodiment, so long as the ranges of dimensions depicted in FIG. 14 are satisfied.

FIG. 15G is a diagram showing an example where, further in the structure of FIG. 15F, portions of the conductive surface 110a that are opposed to the conductive rods 124 protrude toward the conductive rods 124. Even such a structure will operate in a similar manner to the above-described example embodiment, so long as the ranges of dimensions depicted in FIG. 14 are satisfied. Instead of a structure in which the conductive surface 110a partially protrudes, a structure in which the conductive surface 110a is partially dented may be adopted.

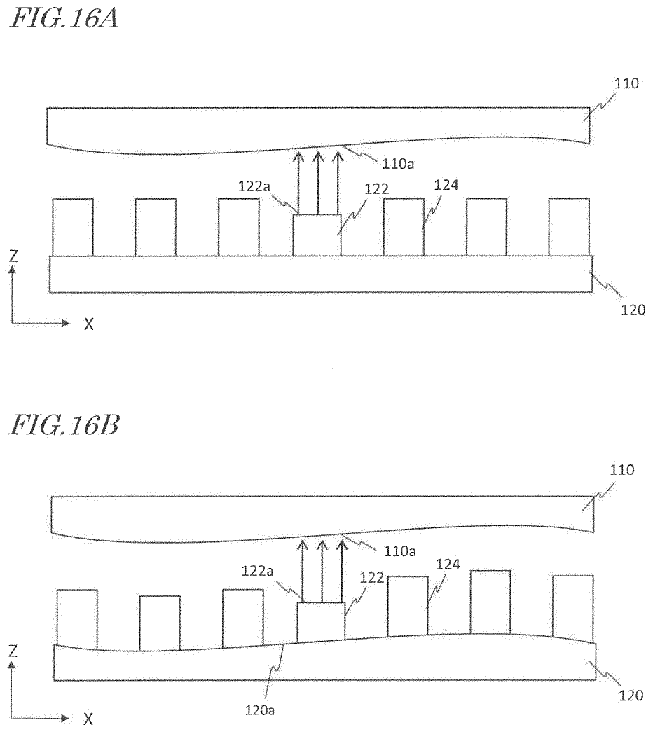

FIG. 16A is a diagram showing an example where a conductive surface 110a of the conductive member 110 is shaped as a curved surface. FIG. 16B is a diagram showing an example where also a conductive surface 120a of the conductive member 120 is shaped as a curved surface. As demonstrated by these examples, the conductive surfaces 110a and 120a may not be shaped as planes, but may be shaped as curved surfaces. A conductive member having a conductive surface which is a curved surface is also qualifies as a conductive member having a “plate shape”.

In the waveguide device 100 of the above-described construction, a signal wave of the operating frequency is unable to propagate in the space between the surface 125 of the artificial magnetic conductor and the conductive surface 110a of the conductive member 110, but propagates in the space between the waveguide face 122a of the waveguide member 122 and the conductive surface 110a of the conductive member 110. Unlike in a hollow waveguide, the width of the waveguide member 122 in such a waveguide structure does not need to be equal to or greater than a half of the wavelength of the electromagnetic wave to propagate. Moreover, the conductive member 110 and the conductive member 120 do not need to be electrically interconnected by a metal wall that extends along the thickness direction (i.e., in parallel to the YZ plane).

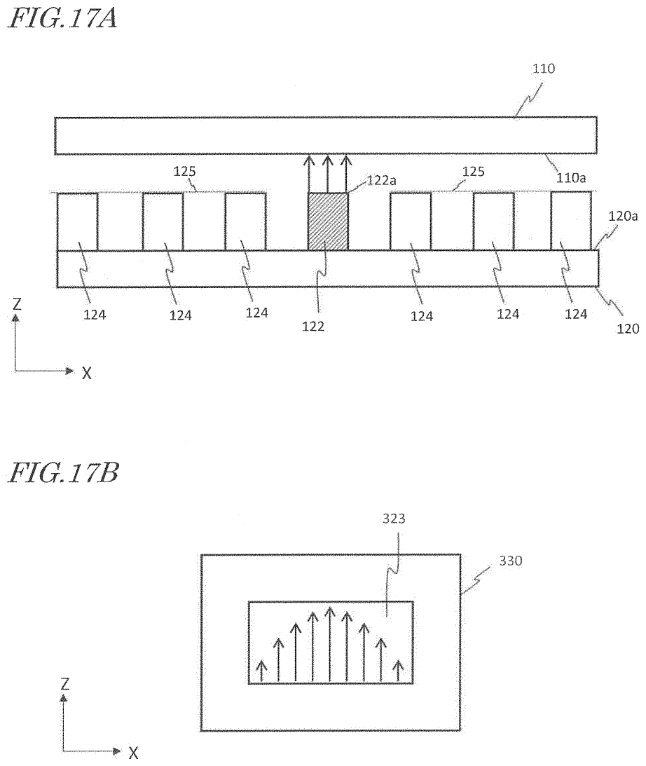

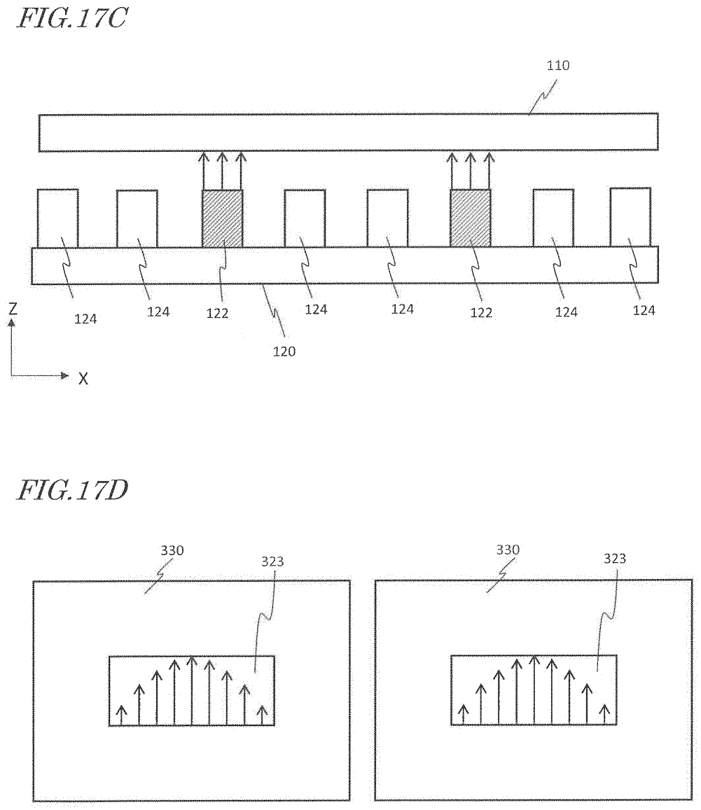

FIG. 17A schematically shows an electromagnetic wave that propagates in a narrow space, i.e., a gap between the waveguide face 122a of the waveguide member 122 and the conductive surface 110a of the conductive member 110. Three arrows in FIG. 17A schematically indicate the orientation of an electric field of the propagating electromagnetic wave. The electric field of the propagating electromagnetic wave is perpendicular to the conductive surface 110a of the conductive member 110 and to the waveguide face 122a.

On both sides of the waveguide member 122, stretches of artificial magnetic conductor that are created by the plurality of conductive rods 124 are present. An electromagnetic wave propagates in the gap between the waveguide face 122a of the waveguide member 122 and the conductive surface 110a of the conductive member 110. FIG. 17A is schematic, and does not accurately represent the magnitude of an electromagnetic field to be actually created by the electromagnetic wave. A part of the electromagnetic wave (electromagnetic field) propagating in the space over the waveguide face 122a may have a lateral expanse, to the outside (i.e., toward where the artificial magnetic conductor exists) of the space that is delineated by the width of the waveguide face 122a. In this example, the electromagnetic wave propagates in a direction (i.e., the Y direction) which is perpendicular to the plane of FIG. 17A. As such, the waveguide member 122 does not need to extend linearly along the Y direction, but may include a bend(s) and/or a branching portion(s) not shown. Since the electromagnetic wave propagates along the waveguide face 122a of the waveguide member 122, the direction of propagation would change at a bend, whereas the direction of propagation would ramify into plural directions at a branching portion.

In the waveguide structure of FIG. 17A, no metal wall (electric wall), which would be indispensable to a hollow waveguide, exists on both sides of the propagating electromagnetic wave. Therefore, in the waveguide structure of this example, “a constraint due to a metal wall (electric wall)” is not included in the boundary conditions for the electromagnetic field mode to be created by the propagating electromagnetic wave, and the width (size along the X direction) of the waveguide face 122a is less than a half of the wavelength of the electromagnetic wave.

For reference, FIG. 17B schematically shows a cross section of a hollow waveguide 330. With arrows, FIG. 17B schematically shows the orientation of an electric field of an electromagnetic field mode (TE₁₀) that is created in the internal space 323 of the hollow waveguide 330. The lengths of the arrows correspond to electric field intensities. The width of the internal space 323 of the hollow waveguide 330 needs to be set to be broader than a half of the wavelength. In other words, the width of the internal space 323 of the hollow waveguide 330 cannot be set to be smaller than a half of the wavelength of the propagating electromagnetic wave.

FIG. 17C is a cross-sectional view showing an implementation where two waveguide members 122 are provided on the conductive member 120. Thus, an artificial magnetic conductor that is created by the plurality of conductive rods 124 exists between the two adjacent waveguide members 122. More accurately, stretches of artificial magnetic conductor created by the plurality of conductive rods 124 are present on both sides of each waveguide member 122, such that each waveguide member 122 is able to independently propagate an electromagnetic wave.

For reference's sake, FIG. 17D schematically shows a cross section of a waveguide device in which two hollow waveguides 330 are placed side-by-side. The two hollow waveguides 330 are electrically insulated from each other. Each space in which an electromagnetic wave is to propagate needs to be surrounded by a metal wall that defines the respective hollow waveguide 330. Therefore, the interval between the internal spaces 323 in which electromagnetic waves are to propagate cannot be made smaller than a total of the thicknesses of two metal walls. Usually, a total of the thicknesses of two metal walls is longer than a half of the wavelength of a propagating electromagnetic wave. Therefore, it is difficult for the interval between the hollow waveguides 330 (i.e., interval between their centers) to be shorter than the wavelength of a propagating electromagnetic wave. Particularly for electromagnetic waves of wavelengths in the extremely high frequency range (i.e., electromagnetic wave wavelength: 10 mm or less) or even shorter wavelengths, a metal wall which is sufficiently thin relative to the wavelength is difficult to be formed. This presents a cost problem in commercially practical implementation.

On the other hand, a waveguide device 100 including an artificial magnetic conductor can easily realize a structure in which waveguide members 122 are placed close to one another. Thus, such a waveguide device 100 can be suitably used in an antenna array that includes plural antenna elements in a close arrangement.

### <Antenna Device>

Next, an example embodiment of an antenna device according to the present disclosure will be described. The antenna device includes a waveguide device according to any of the aforementioned example embodiments and at least one antenna element that is connected to the waveguide device. The waveguide device has a structured which, as described above, allows a coaxial cable and a ridge waveguide to be connected. The ridge waveguide in the waveguide device is connected to the at least one antenna element. The at least one antenna element has at least one of the function of radiating into space an electromagnetic wave that has propagated through the waveguide in the waveguide device, and the function of introducing an electromagnetic wave that has propagated in space into the waveguide in the waveguide device. In other words, the antenna device according to the present example embodiment is used for at least one of transmission and reception of signals.

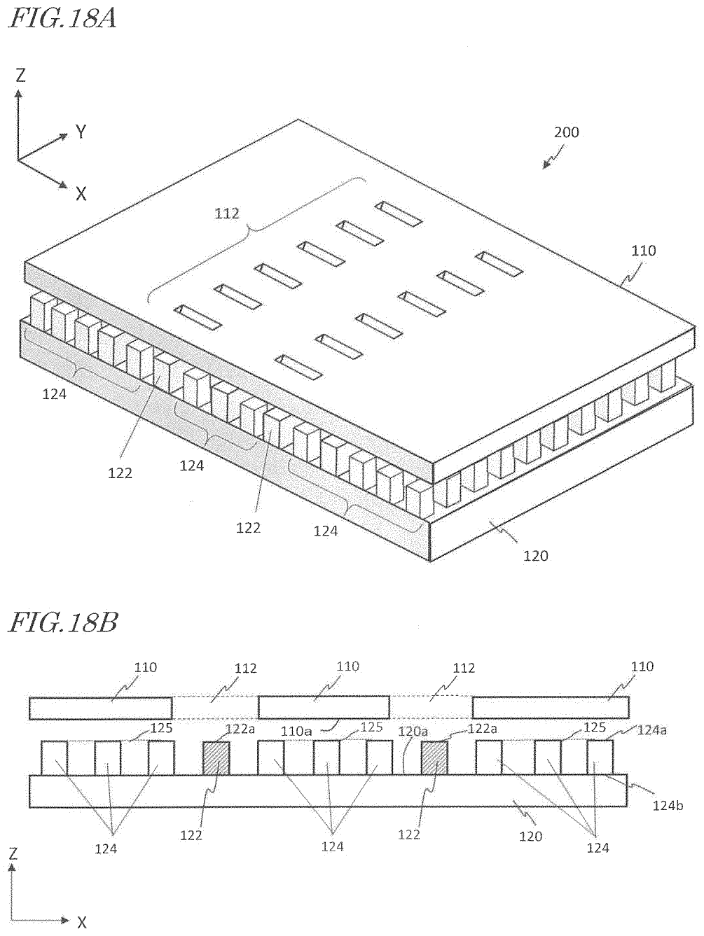

FIG. 18A is a perspective view schematically showing a portion of the construction of a slot antenna array 200 as an example of an antenna device utilizing the aforementioned waveguide structure. FIG. 18B is a diagram showing schematically showing a portion of a cross section taken parallel to an XZ plane which passes through the centers of two adjacent slots 112 along the X direction of the slot antenna array 200. In the slot antenna array 200, the conductive member 110 has a plurality of slots 112 arranged along the X direction and the Y direction. In this example, the plurality of slots 112 include two slot rows, each slot row including six slots 112 arranged at an equal interval along the Y direction. On the conductive member 120, two waveguide members 122 extending along the Y direction are provided. Each waveguide member 122 has an electrically-conductive waveguide face 122a opposing one slot row. In a region between the two waveguide members 122 and in regions outside of the two waveguide members 122, a plurality of conductive rods 124 are disposed. These conductive rods 124 constitute an artificial magnetic conductor.

From a transmission circuit not shown, an electromagnetic wave is supplied to a waveguide extending between the waveguide face 122a of each waveguide member 122 and the conductive surface 110a of the conductive member 110. Among the plurality of slots 112 arranged along the Y direction, the distance between the centers of two adjacent slots 112 is designed so as to be equal in value to the wavelength of an electromagnetic wave propagating in the waveguide, for example. As a result of this, electromagnetic waves with an equal phase can be radiated from the six slots 112 arranged along the Y direction.

The slot antenna array 200 shown in FIG. 18A and FIG. 18B is an antenna array in which the plurality of slots 112 serve as antenna elements (radiating elements). With such construction of the slot antenna array 200, the interval between the centers of antenna elements can be made shorter than a wavelength λo in free space of an electromagnetic wave propagating through the waveguide, for example. Horns may be provided for the plurality of slots 112. By providing horns, radiation characteristics or reception characteristics can be improved. As the horns, the horn of each antenna element 111A as has been described with reference to FIG. 1 to FIG. 13 can be used, for example.

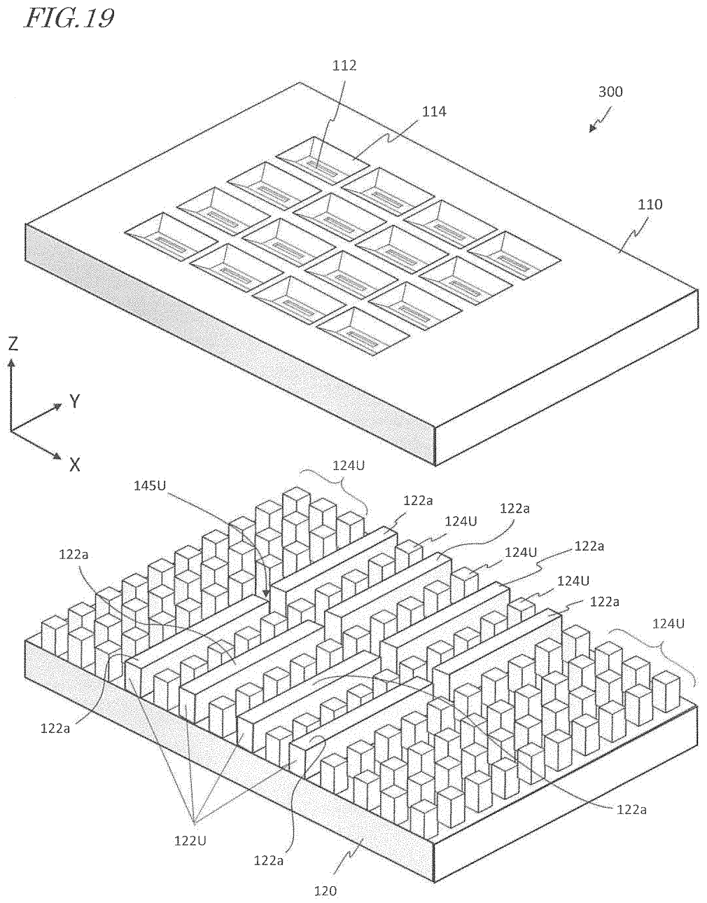

FIG. 19 is a perspective view schematically showing a portion of the structure of a slot antenna array 300 which has horn 114 for each slot 112. The slot antenna array 300 includes: a conductive member 110 having a plurality of slots 112 and a plurality of horns 114 arranged in a two-dimensional array; and a conductive member 120 on which a plurality of waveguide members 122U and a plurality of conductive rods 124U are arranged. FIG. 19 is illustrated so that the spacing between the conductive members 110 and 120 is exaggerated. The plurality of slots 112 in the conductive member 110 are arranged along a first direction which extends along the conductive surface 110a of the conductive member 110 (the Y direction) and a second direction (the X direction) which intersects (e.g., orthogonal in this example) the first direction. FIG. 19 also shows a port (throughhole) 145U that is disposed in the center of each waveguide member 122U. The choke structures which may be disposed at both ends of the waveguide member 122U are omitted from illustration. Although the present example embodiment illustrates that there are four waveguide members 122U, the number of waveguide members 122U may be arbitrary. In the present example embodiment, each waveguide member 122U is split into two portions at the position of the port 145U in the middle.

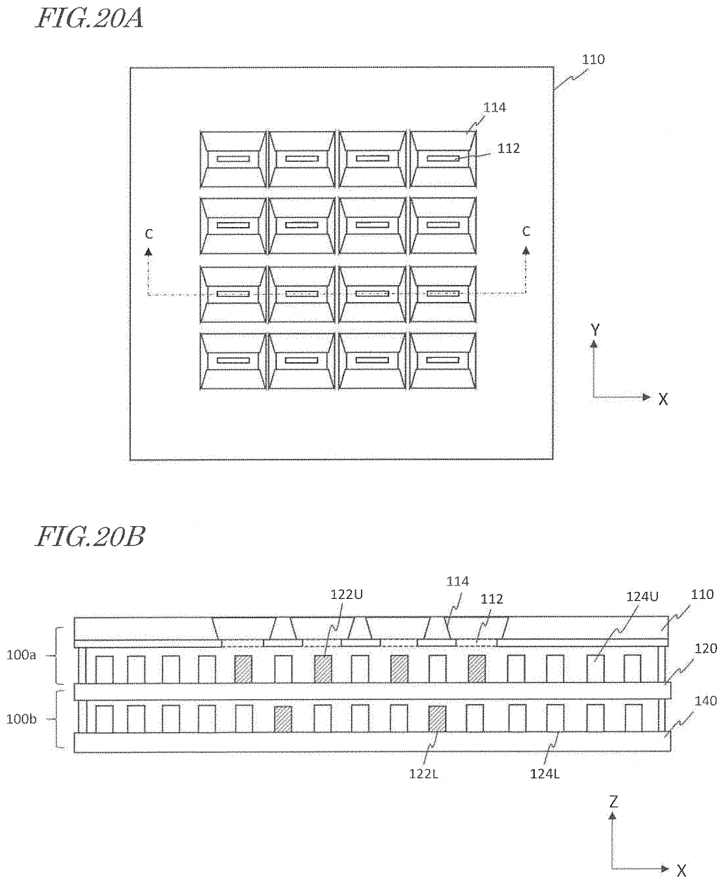

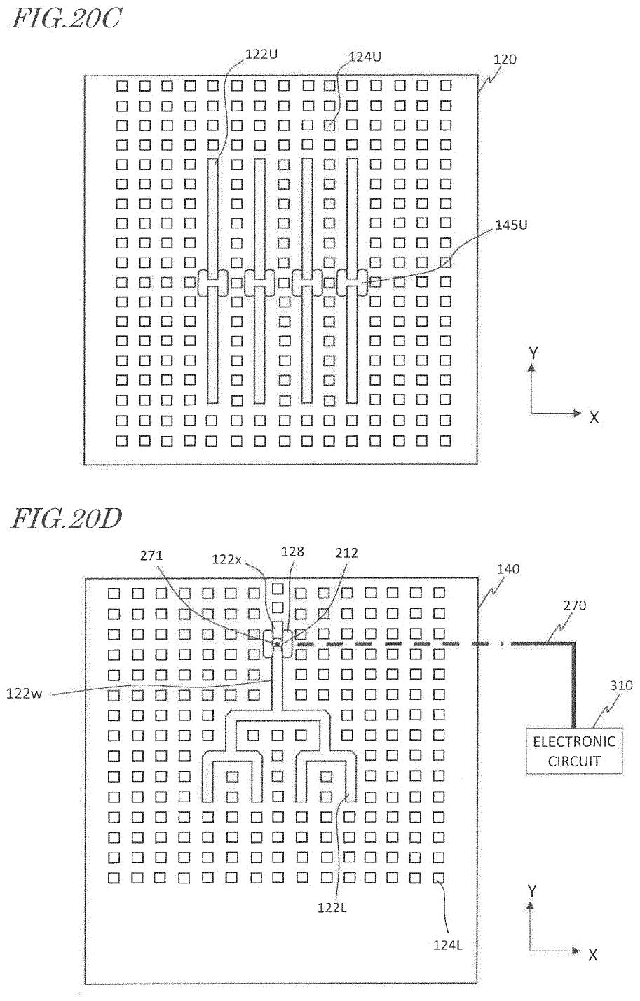

FIG. 20 is an upper plan view showing an antenna array 300 in which 16 slots are arranged in four rows and four columns as shown in FIG. 19, as viewed along the Z direction. FIG. 20B is a cross-sectional view taken along line C-C in FIG. 20A. The conductive member 110 in the antenna array 300 includes the plurality of horns 114, which are provided respectively corresponding to the plurality of slots 112. Each of the plurality of horns 114 includes four electrically conductive walls surrounding the slot 112. With such horns 114, directivity can be improved.

In the illustrated antenna array 300, a first waveguide device 100a and a second waveguide device 100b are layered, the first waveguide device 100a including first waveguide members 122U that directly couple to the slots 112, and the second waveguide device 100b including a second waveguide member 122L that couples to the waveguide members 122U on the first waveguide device 100a. The waveguide member 122L and the conductive rods 124L of the second waveguide device 100b are disposed on a conductive member 140. The second waveguide device 100b basically has a similar construction to the construction of the first waveguide device 100a.

As shown in FIG. 20A, the conductive member 110 includes a plurality of slots 112 that are arranged along the first direction (the Y direction) and the second direction (the X direction) which is orthogonal to the first direction. The waveguide faces 122a of the plurality of waveguide members 122U extend along the Y direction are opposed to four slots that are arranged side by side along the Y direction, among the plurality of slots 112. Although this example illustrates that the conductive member 110 has 16 slots 112 that are arranged in four rows and four columns, the number and arrangement of slots 112 are not limited to this example. Without being limited to the example where the waveguide members 122U are opposed to all slots among the plurality of slots 112 that are arranged side by side along the Y direction, there may be waveguide members 122U opposed to at least two adjacent slots along the Y direction. The interval between the centers of two adjacent waveguide faces 122a along the X direction may be set to be shorter than the wavelength λo, and more preferably shorter than the wavelength λo/2, for example.

FIG. 20C is a diagram showing a planar layout of the waveguide members 122U on the first waveguide device 100a. FIG. 20D is a diagram showing a planar layout of the waveguide member 122L on the second waveguide device 100b. As shown in these figures, the waveguide members 122U on the first waveguide device 100a extend in linear shapes (stripes), without having any branching portions or bends. On the other hand, the waveguide member 122L on the second waveguide device 100b includes both of branching portions and bends.

The waveguide members 122U on the first waveguide device 100a couple to the waveguide member 122L on the second waveguide device 100b via the ports (apertures) 145U of the conductive member 120. In other words, an electromagnetic wave which has propagated along the waveguide member 122L on the second waveguide device 100b passes through the port 145U to reach the waveguide member 122U on the first waveguide device 100a, thereby being able to propagate through the waveguide member 122U on the first waveguide device 100a. In this case, each slot 112 functions as an antenna element to allow an electromagnetic wave which has propagated through the waveguide to be radiated into space. Conversely, when an electromagnetic wave which has propagated in space impinges on a slot 112, the electromagnetic wave couples to the waveguide member 122U on the first waveguide device 100a that lies immediately under that slot 112, and propagates along the waveguide member 122U on the first waveguide device 100a. An electromagnetic wave which has propagated along a waveguide member 122U of the first waveguide device 100a may also pass through the port 145U to reach the ridge 122L on the second waveguide device 100b, and propagate along the ridge 122L.

As shown in FIG. 20D, the waveguide member 122L of the second waveguide device 100b includes one stem-like portion and four branch-like portions which branch out from the stem-like portion. The stem-like portion of the waveguide member 122L extends along the Y direction, and is split into a first ridge 122w and a second ridge 122x. At the position of a gap between the first ridge 122w and the second ridge 122x, the conductive member 140 has a throughhole 212. In the throughhole 212, a coaxial cable 270 or a connector that is connected to the coaxial cable 270 is inserted. The core 271 of the coaxial cable 270 or the connector is connected to an end face of the first ridge 122w or the second ridge 122x. The connection structure between the core 271 and the waveguide member 122L is similar to the connection structure according to the second example embodiment which has been described with reference to FIG. 2A and FIG. 2B. Instead of this connection structure, the connection structure in any of the other example embodiments above may be adopted. The coaxial cable 270 is connected to an electronic circuit 310 that generates or receives a radio frequency signal.

Without being limited to a specific position, the electronic circuit 310 may be provided at any arbitrary position. The electronic circuit 310 may be provided on a circuit board which is on the rear surface side (i.e., the lower side in FIG. 20B) of the conductive member 140, for example. Such an electronic circuit may include a microwave integrated circuit, e.g. an MMIC (Monolithic Microwave Integrated Circuit) that generates or receives millimeter waves, for example. In addition to the microwave integrated circuit, the electronic circuit 310 may further include another circuit, e.g., a signal processing circuit. Such a signal processing circuit may be configured to execute various processes that are necessary for the operation of a radar system that includes an antenna device, for example. The electronic circuit 310 may include a communication circuit. The communication circuit may be configured to execute various processes that are necessary for the operation of a communication system that includes an antenna device.

Note that a structure for connecting an electronic circuit to a waveguide is disclosed in, for example, US Patent Publication No. 2018/0351261, US Patent Publication No. 2019/0006743, US Patent Publication No. 2019/0139914, US Patent Publication No. 2019/0067780, US Patent Publication No. 2019/0140344, and International Patent Application Publication No. 2018/105513. The entire disclosure of these publications is incorporated herein by reference.

The conductive member 110 shown in FIG. 20A may be called a “radiation layer”. The layer containing the entirety of the conductive member 120, the waveguide members 122U, and the conductive rods 124U shown in FIG. 20C may be called an “excitation layer”; and the layer containing the entirety of the conductive member 140, the waveguide member 122L, and the conductive rods 124L shown in FIG. 20D may be called a “distribution layer”. Moreover, the “excitation layer” and the “distribution layer” may be collectively called a “feeding layer”. Each of the “radiation layer”, the “excitation layer” and the “distribution layer” can be mass-produced by processing a single metal plate. The radiation layer, the excitation layer, the distribution layer, and any electronic circuitry to be provided on the rear face side of the distribution layer may be produced as a single-module product.

In the antenna array of this example, as can be seen from FIG. 20B, a plate-like radiation layer, excitation layer, and distribution layer are layered, so that, as a whole, a flat panel antenna which is flat and low-profiled is realized. For example, the height (thickness) of a multilayer structure having a cross-sectional construction as shown in FIG. 20B can be made 10 mm or less.

The waveguide member 122L shown in FIG. 20D includes one stem-like portion that is connected to the core 271, and four branch-like portions which branch out from the stem-like portion. The four ports 145U are respectively opposed to the upper faces of the leading ends of the four branch-like portions. The distances from the throughhole 212 to the four ports 145U of the conductive member 120 as measured along the waveguide member 122L are all equal. Therefore, a signal wave which is input from the throughhole 212 of the conductive member 140 to the waveguide member 122L reaches the four ports 145U, which are disposed in the center of the waveguide member 122U along the Y direction, all in the same phase. As a result, the four waveguide members 122U on the conductive member 120 can be excited in the same phase.

Depending on the application, it is not necessary for all slots 112 functioning as antenna elements to radiate electromagnetic waves in the same phase. The network patterns of the waveguide members 122U and 122L in the excitation layer and the distribution layer may be arbitrary, without being limited to what is shown in the figures.

When constructing an excitation layer and a distribution layer, various circuit elements in waveguides can be utilized. Examples thereof are disclosed in U.S. Pat. Nos. 10,042,045, 10,090,600, 10,158,158, International Patent Application Publication No. 2018/207796, International Patent Application Publication No. 2018/207838, and US Patent Publication No. 2019/0074569, for example. The entire disclosure of these publications is incorporated herein by reference.

An antenna device according to an example embodiment of the present disclosure can be suitably used in a radar device or a radar system to be incorporated in moving entities such as vehicles, marine vessels, aircraft, robots, or the like, for example. A radar device would include an antenna device having the waveguide device according to an example embodiment of the present disclosure and a microwave integrated circuit that is connected to the antenna device. A radar system would include the radar device and a signal processing circuit that is connected to the microwave integrated circuit of the radar device. When an antenna device according to an example embodiment of the present disclosure is combined with a WRG structure which permits downsizing, the area of the face on which the antenna elements are arranged can be reduced as compared to any construction using a conventional hollow waveguide. Therefore, a radar system incorporating the antenna device can be easily installed even in a narrow place. The radar system may be fixed to a road or a building in use, for example. The signal processing circuit may perform a process of estimating the azimuth of an arriving wave based on a signal that is received by a microwave integrated circuit, for example. For example, the signal processing circuit may be configured to execute the MUSIC method, the ESPRIT method, the SAGE method, or other algorithms to estimate the azimuth of the arriving wave, and output a signal indicating the estimation result. Furthermore, the signal processing circuit may be configured to estimate the distance to each target as a wave source of an arriving wave, the relative velocity of the target, and the azimuth of the target by using a known algorithm, and output a signal indicating the estimation result.

In the present disclosure, the term “signal processing circuit” is not limited to a single circuit, but encompasses any implementation in which a combination of plural circuits is conceptually regarded as a single functional part. The signal processing circuit may be realized by one or more System-on-Chips (SoC). For example, a part or a whole of the signal processing circuit may be an FPGA (Field-Programmable Gate Array), which is a programmable logic device (PLD). In that case, the signal processing circuit includes a plurality of computation elements (e.g., general-purpose logics and multipliers) and a plurality of memory elements (e.g., look-up tables or memory blocks). Alternatively, the signal processing circuit may be a set of a general-purpose processor(s) and a main memory device(s). The signal processing circuit may be a circuit which includes a processor core(s) and a memory device(s). These may function as the signal processing circuit.

An antenna device according to an example embodiment of the present disclosure can also be used in a wireless communication system. Such a wireless communication system would include an antenna device having the waveguide device according to any of the above example embodiments and a communication circuit (a transmission circuit or a reception circuit) connected to the antenna device. For example, the transmission circuit may be configured to supply, to a waveguide within the antenna device, a signal wave representing a signal for transmission. The reception circuit may be configured to demodulate a signal wave which has been received via the antenna device, and output it as an analog or digital signal.

An antenna device according to an example embodiment of the present disclosure can further be used as an antenna in an indoor positioning system (IPS). An indoor positioning system is able to identify the position of a moving entity, such as a person or an automated guided vehicle (AGV), that is in a building. An antenna device can also be used as a radio wave transmitter (beacon) for use in a system which provides information to an information terminal device (e.g., a smartphone) that is carried by a person who has visited a store or any other facility. In such a system, once every several seconds, a beacon may radiate an electromagnetic wave carrying an ID or other information superposed thereon, for example. When the information terminal device receives this electromagnetic wave, the information terminal device transmits the received information to a remote server computer via telecommunication lines. Based on the information that has been received from the information terminal device, the server computer identifies the position of that information terminal device, and provides information which is associated with that position (e.g., product information or a coupon) to the information terminal device.

Application examples of radar systems, communication systems, and various monitoring systems that include a slot array antenna having a WRG structure are disclosed in the specifications of U.S. Pat. Nos. 9,786,995 and 10,027,032, for example. The entire disclosure of these publications is incorporated herein by reference. A slot array antenna according to the present disclosure is applicable to each application example that is disclosed in these publications.

A waveguide device according to the present disclosure is usable in any technological field that utilizes an antenna. For example, it is available to various applications where transmission/reception of electromagnetic waves of the gigahertz band or the terahertz band is performed. In particular, they may be suitably used in onboard radar systems, various types of monitoring systems, indoor positioning systems, and wireless communication systems, e.g., Massive MIMO, where downsizing is desired.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A waveguide device comprising:
a first electrical conductor including a first electrically conductive surface including an expanse along a first direction and a second direction which intersects the first direction;
a second electrical conductor including a second electrically conductive surface opposing the first electrically conductive surface and including a throughhole;
a ridge-shaped waveguide protruding from the second electrically conductive surface and extending along the first direction, the waveguide including an electrically-conductive waveguide surface opposing the first electrically conductive surface, and the waveguide being split into a first ridge and a second ridge having a smaller dimension along the first direction than the first ridge via a gap which overlaps the throughhole when viewed from a direction perpendicular or substantially perpendicular to the waveguide surface;
a plurality of electrically conductive rods which are located around the waveguide, each of the plurality of electrically conductive rods including a root that is connected to the second electrically conductive surface and a leading end that is opposed to the first electrically conductive surface; and
a core which is partly accommodated in the throughhole and is connected to an end surface of the first ridge opposing an end surface of the second ridge via the gap or connected to the end surface of the second ridge.

2. The waveguide device of claim 1, further comprising:
a connector, at least a leading end of which is accommodated in the throughhole; and
the core is fixed to the second electrical conductor via the connector.

3. The waveguide device of claim 1, wherein a leading end of the core is in contact with the end surface of the first ridge or the end surface of the second ridge.

4. The waveguide device of claim 1, further comprising:
a connector, at least a leading end of which is accommodated in the throughhole; wherein
the core is fixed to the second electrical conductor via the connector; and
a leading end of the core is in contact with the end surface of the first ridge or the end surface of the second ridge.

5. The waveguide device of claim 1, wherein
the end surface of the first ridge or the end surface of the second ridge includes a protrusion;
the protrusion is located between the waveguide surface and a root of the waveguide along a height direction of the waveguide; and
the core is connected to the protrusion.

6. The waveguide device of claim 1, further comprising:
a connector, at least a leading end of which is accommodated in the throughhole; wherein
the core is fixed to the second electrical conductor via the connector;
a leading end of the core is in contact with the end surface of the first ridge or the end surface of the second ridge; and
the protrusion includes a surface located at one of the end surface of the first ridge or the end surface of the second ridge that is closer to the waveguide surface and is continuous with the waveguide surface.

7. The waveguide device of claim 5, wherein the protrusion is located at a position spaced from both of the waveguide surface and the second electrically conductive surface.

8. The waveguide device of claim 1, wherein one of the end surface of the first ridge and the end surface of the second ridge that is not connected to the core includes a stepped portion or a slope.

9. The waveguide device of claim 1, wherein
one of the end surface of the first ridge and the end surface of the second ridge that is not connected to the core includes a stepped portion or a slope;
the end surface of the first ridge or the end surface of the second ridge includes a protrusion;
along a height direction of the waveguide, the protrusion is located between the waveguide surface and a root of the waveguide; and
the core is connected to the protrusion.

10. The waveguide device of claim 1, wherein
the second electrical conductor includes a recess surrounding the throughhole in the second electrically conductive surface; and
the throughhole opens at a bottom of the recess.

11. The waveguide device of claim 1, further comprising:
a connector, at least a leading end of which is accommodated in the throughhole; wherein
the core is fixed to the second electrical conductor via the connector;
the second electrical conductor includes a recess surrounding the throughhole in the second electrically conductive surface; and
the throughhole opens at a bottom of the recess.

12. The waveguide device of claim 1, wherein
the end surface of the first ridge or the end surface of the second ridge includes a protrusion;
along a height direction of the waveguide, the protrusion is located between the waveguide surface and a root of the waveguide;
the core is connected to the protrusion;
the second electrical conductor includes a recess surrounding the throughhole in the second electrically conductive surface; and
the throughhole opens at a bottom of the recess.

13. The waveguide device of claim 1, wherein
the second electrical conductor includes a recess surrounding the throughhole in the second electrically conductive surface;
the throughhole opens at a bottom of the recess;
regarding the end surface of the first ridge and the end surface of the second ridge, the end surface that is not connected to the core has a stepped portion or a slope;
the end surface of the first ridge or the end surface of the second ridge includes a protrusion;
along a height direction of the waveguide, the protrusion is located between the waveguide surface and a root of the waveguide; and
the core is connected to the protrusion.

14. The waveguide device of claim 1, wherein one or more electrically conductive rods among the plurality of electrically conductive rods define a choke structure including (i) a row of rods that are adjacent to the second ridge along the first direction and (ii) the second ridge.

15. The waveguide device of claim 1, wherein
an electromagnetic wave having a center frequency of an operating frequency band of the waveguide device has a wavelength of λo in free space; and
a dimension of the second ridge along the first direction is greater than λo/16 and smaller than λo/2.

16. A waveguide device comprising:
a first electrical conductor including a first electrically conductive surface including an expanse along a first direction and a second direction which intersects the first direction, and a bottomed hole which opens in the first electrically conductive surface;
a second electrical conductor including a second electrically conductive surface opposing the first electrically conductive surface and including a throughhole which overlaps the hole when viewed from a direction perpendicular or substantially perpendicular to the second electrically conductive surface;
a ridge-shaped waveguide protruding from the second electrically conductive surface and extending along the first direction, the waveguide including an electrically-conductive waveguide surface opposing the first electrically conductive surface, and the waveguide being split into a first ridge and a second ridge including a smaller dimension along the first direction than the first ridge via a gap which overlaps the hole and the throughhole when viewed from a direction perpendicular or substantially perpendicular to the second electrically conductive surface;
a plurality of electrically conductive rods which are located around the waveguide, each including a root that is connected to the second electrically conductive surface and a leading end that is opposed to the first electrically conductive surface; and
a coaxial cable being partly accommodated in the throughhole and including a core that is located inside the gap and the hole, such that an electrical insulator or a gap exists between the core and an inner peripheral surface of the hole.

17. A waveguide device comprising:
a first electrical conductor including a first electrically conductive surface including an expanse along a first direction and a second direction which intersects the first direction, and a bottomed hole which opens in the first electrically conductive surface;
a second electrical conductor including a second electrically conductive surface opposing the first electrically conductive surface and a first throughhole which overlaps the hole when viewed from a direction perpendicular to the second electrically conductive surface;
a ridge-shaped waveguide protruding from the second electrically conductive surface and extending along the first direction, the waveguide including an electrically-conductive waveguide surface opposing the first electrically conductive surface and including a second throughhole which overlaps the hole and the first throughhole when viewed from a direction perpendicular or substantially perpendicular to the second electrically conductive surface;
a plurality of electrically conductive rods which are located around the waveguide, each including a root that is connected to the second electrically conductive surface and a leading end that is opposed to the first electrically conductive surface; and
a coaxial cable being partly accommodated in the first throughhole and the second throughhole and including a core that is located inside the first throughhole, the second throughhole, and the hole, such that an electrical insulator or a gap exists between the core and an inner peripheral surface of the hole.

18. A wireless communication system comprising:
the waveguide device of claim 1;
at least one antenna element that is connected to the waveguide device; and
a communication circuit that is connected to the waveguide device.

19. A wireless communication system comprising:
the waveguide device of claim 16;
at least one antenna element that is connected to the waveguide device; and
a communication circuit that is connected to the waveguide device.

20. A wireless communication system comprising:
the waveguide device of claim 17;
at least one antenna element that is connected to the waveguide device; and
a communication circuit that is connected to the waveguide device.
